(19) United States
(12) Patent Application Publication
(10) Pub. No.: US 2018/0040207 A1
(43) Pub. Date: Feb. 8, 2018

(54) INFORMATION PROCESSING DEVICE, CONTROL METHOD AND INFORMATION PROCESSING SYSTEM

(71) Applicant: NEC Corporation, Tokyo (JP)

(72) Inventor: Yoshikazu KOBAYASHI, Tokyo (JP)

(21) Appl. No.: 15/528,011

(22) PCT Filed: Nov. 18, 2015
(86) PCT No.: PCT/JP2015/082362

§ 371 Date: May 18, 2017

(30) Foreign Application Priority Data
Nov. 19, 2014 (JP) 2014-235111

(51) Int. Cl. G07G 1/14; G06F 9/54; G06F 9/44; G06F 9/445

(52) U.S. Cl. CPC G07G 1/14; G06F 9/44584; G06F 9/54; G06F 9/4411

(57) ABSTRACT

A system of the present invention is an information processing system for stably activating an application using a desired device. The information processing device includes: an application storage unit that stores an application associated with a device required for execution of the application; a device determining unit that determines whether the device is usable depending on whether a device driver for the device is activated; and application activation unit that activates the application associated with the device that is determined to be usable.

### TECHNICAL FIELD

The present invention relates to an information processing system, an information processing method, an information processing device, a control method thereof, and a control program for the same.

### BACKGROUND ART

In the above technical field, Patent Literature 1 discloses a technique for starting up (activating) application software for executing business of a POS (Point of Sales) terminal when a keyboard, a hand scanner, and a printer can be recognized via the USB (Universal Serial Bus) interface at the time of power-on of the POS terminal in a POS system.

### CITATION LIST

### [Patent Literature]

PTL 1: Japanese Patent Laid-Open No. 2008-003927

### SUMMARY OF INVENTION

### Technical Problem

However, in the technique described in the above patent literature, when a device essential for the application software of the POS terminal is connected to a remote USB interface, the device may not be stably recognized from the FOB terminal in some cases. In that case, even if the essential device is not operable, the application software may be activated, or on the contrary, even if the essential device is operable, the application software may not be activated.

It is an object of the present invention to provide a technique for solving the above problems.

### [Solution to Problem]

To achieve the above objective, an information processing device according to the present invention includes:
application storage means that associates and stores an application and a device required for execution of the application;
device determining means that determines whether the device is usable depending on whether a device driver for the device is activated; and
application activation means that activates the application associated with the device that is determined to be usable.

To achieve the above objective, a control method of an information processing device according to the present invention, includes:
a device determining step of determining whether a device is usable depending on whether a device driver for the device is activated; and
an application activate step of referring to application storage means that associates and stores an application and a device required for execution of the application to activate the application associated with the device that is determined to be usable.

To achieve the above objective, a control program of an information processing apparatus according to the present invention, causing a computer to execute:
a device determining step of determining whether a device is usable depending on whether a device driver for the device is activated; and
an application activation step of referring to application storage means that associates and stores an application and a device required for execution of the application to activate the application associated with the device that is determined to be usable.

To achieve the above objective, an information processing system includes:
an information processing device;
a communication terminal communicatively connected to the information processing device; and
a device connected to the communication terminal,
wherein the information processing device includes an application interface of a device driver driving the device, and the communication terminal includes a device control interface of the device driver, and
wherein the information processing device includes:
application storage means that associates and stores an application and a device required for execution of the application;
device determining means that determines whether the device is usable depending on whether the application interface of the device driver is activated; and
application activation means that activates the application associated with the device that is determined to be usable.

To achieve the above objective, in an information processing method of an information processing system, according to present invention, the information processing system includes: an information processing device; a communication terminal communicatively connected to the information processing device; and a device connected to the communication terminal.

The information processing device includes an application interface of a device driver driving the device, and the communication terminal includes a device control interface of the device driver.

The information processing device further includes application storage means that associates and stores an application and the device required for execution of the application, and
the information processing device includes middleware. The middleware includes:
a device determining step of determining whether a device is usable depending on whether a device driver for the device is activated; and
an application activation step of referring to the application storage means to activate the application associated with the device that is determined to be usable.

### [Advantageous Effects of Invention]

According to the present invention, an application using a desired device can be activated stably.

### BRIEF DESCRIPTION OF DRAWINGS

FIG. 1 is a block diagram illustrating a configuration of an information processing device according to a first example embodiment of the present invention.

FIG. 2A is a figure illustrating an operation of an information processing system including an information processing device and a remote device according to a second example embodiment of the present invention.

FIG. 2B is a figure illustrating a configuration of an information processing system according to the second example embodiment of the present invention.

FIG. 2C is a figure illustrating a concept of the information processing system according to the second example embodiment of the present invention.

FIG. 2D is a figure illustrating a device connection of the information processing system according to the second example embodiment of the present invention.

FIG. 2E is a figure illustrating a configuration of a communication message according to the second example embodiment of the present invention.

FIG. 2F is a figure illustrating a configuration of communication data according to the second example embodiment of the present invention.

FIG. 2G is a figure illustrating data transmission of the information processing system according to the second example embodiment of the present invention.

FIG. 3 is a figure illustrating a configuration of software of the information processing system according to the second example embodiment of the present invention.

FIG. 4 is a block diagram illustrating a configuration of functions of the information processing device according to the second example embodiment of the present invention.

FIG. 5 is a block diagram illustrating a configuration of functions of a communication terminal according to the second example embodiment of the present invention.

FIG. 6 is a figure illustrating a configuration of an application activation table according to the second example embodiment of the present invention.

FIG. 7 is a block diagram illustrating a configuration of hardware of the information processing device according to the second example embodiment of the present invention.

FIG. 8 is a flowchart illustrating a procedure of processing of the information processing device according to the second example embodiment of the present invention.

FIG. 9 is a flowchart illustrating a procedure of application activation processing according to the second example embodiment of the present invention.

FIG. 10A is a figure illustrating an operation of an information processing system including an information processing device and a remote device according to a third example embodiment of the present invention.

FIG. 10B is a figure illustrating a configuration of a communication message according to the third example embodiment of the present invention.

FIG. 11 is a figure illustrating a configuration of an application activation table according to the third example embodiment of the present invention.

FIG. 12 is a flowchart illustrating a procedure of application activation processing according to the third example embodiment of the present invention.

FIG. 13 is a figure illustrating a configuration of an application activation table according to a fourth example embodiment of the present invention.

FIG. 14 is a flowchart illustrating a procedure of application activation processing according to the fourth example embodiment of the present invention.

FIG. 15A is a figure illustrating an operation of an information processing system including an information processing device and a remote device according to a fifth example embodiment of the present invention.

FIG. 15B is a figure illustrating an operation of operation sharing of the information processing system according to the fifth example embodiment of the present invention.

FIG. 16A is a figure illustrating a configuration of operation sharing of the information processing system according to the fifth example embodiment of the present invention.

FIG. 16B is a figure illustrating a concept of operation sharing of the information processing system according to the fifth example embodiment of the present invention.

FIG. 17 is a figure illustrating a configuration of application activation and an operation sharing table according to the fifth example embodiment of the present invention.

FIG. 18 is a flowchart illustrating a procedure of execution state accumulation processing according to the fifth example embodiment of the present invention.

FIG. 19 is a figure illustrating an operation of an information processing system including an information processing device and a remote device according to a sixth example embodiment of the present invention.

FIG. 20 is a flowchart illustrating a procedure of execution state accumulation processing according to the sixth example embodiment of the present invention.

FIG. 21 is a figure illustrating an operation of an information processing system including an information processing device and a remote device according to a seventh example embodiment of the present invention.

FIG. 22 is a figure illustrating a configuration of application activation and an associated application table according to a seventh example embodiment of the present invention.

FIG. 23 is a flowchart illustrating a procedure of execution state accumulation processing according to the seventh example embodiment of the present invention.

FIG. 24A is a figure illustrating an operation of an information processing system including an information processing device and a remote device according to an eighth example embodiment of the present invention.

FIG. 24B is a figure illustrating a configuration of the information processing system according to the eighth example embodiment of the present invention.

FIG. 25 is a sequence diagram illustrating an operation procedure of the information processing system according to the eighth example embodiment of the present invention.

FIG. 26 is a figure illustrating a configuration of an application activation table according to the eighth example embodiment of the present invention.

FIG. 27 is a flowchart illustrating a procedure of application activation processing according to the eighth example embodiment of the present invention.

FIG. 28 is a figure illustrating data transmission of an information processing system according to a ninth example embodiment of the present invention.

FIG. 29 is a figure illustrating another data transmission of the information processing system according to the ninth example embodiment of the present invention.

### DESCRIPTION OF EMBODIMENTS

Example embodiments of the present invention will be hereinafter exemplarily described in details with reference to the drawings. However, the constituent elements described in the following example embodiments are merely exemplification, and it is to be understood that the technical scope of the present invention is not limited thereto.

### First Example Embodiment

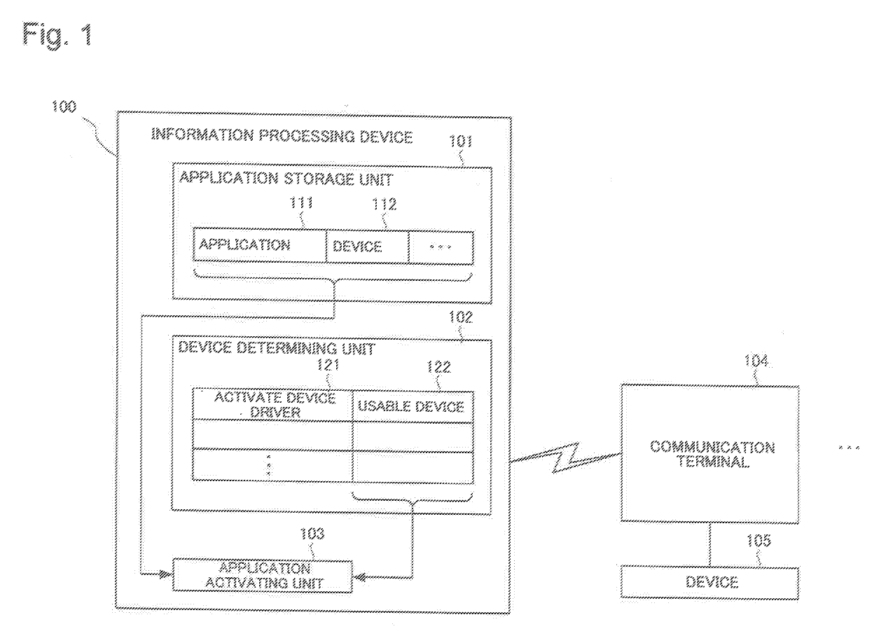

An information processing device 100 serving as a first example embodiment of the present invention will be described with reference to FIG. 1. The information processing device 100 is a device that executes an application using a device.

As shown in FIG. 1, the information processing device 100 includes an application storage unit 101, a device determining unit 102, and an application activation unit 103, the application storage unit 101 associates and stores an application 111 and a device 105 (112) needed to execute the application 111. The device determining unit 102 determines whether the device is usable 122 in accordance with whether the device driver 121 for the device 105 has been activated. The application activation unit 103 activates the application 111 associated with the device 105 that is determined to be usable.

According to the present example embodiment, the application using the desired device can be stably activated by determining the activation of the device drive for the remote device.

### Second Example Embodiment

Subsequently, an information processing system including an information processing device according to the second example embodiment of the present invention will be explained. The information processing system according to the present example embodiment includes an information processing device and a remote device, and activates an application related to the information processing device by detecting that the remote device is ready. Therefore, this can avoid a problem that essential devices are not ready even though an application has been activated. In the present example embodiment, a POS system is used for explanation as a specific example, but similar effects can be obtained even if the present invention is applied to another information processing system including an information processing device and a remote device, a diagnosis support system, an education support system, and the like.

### <<Information Processing System>>

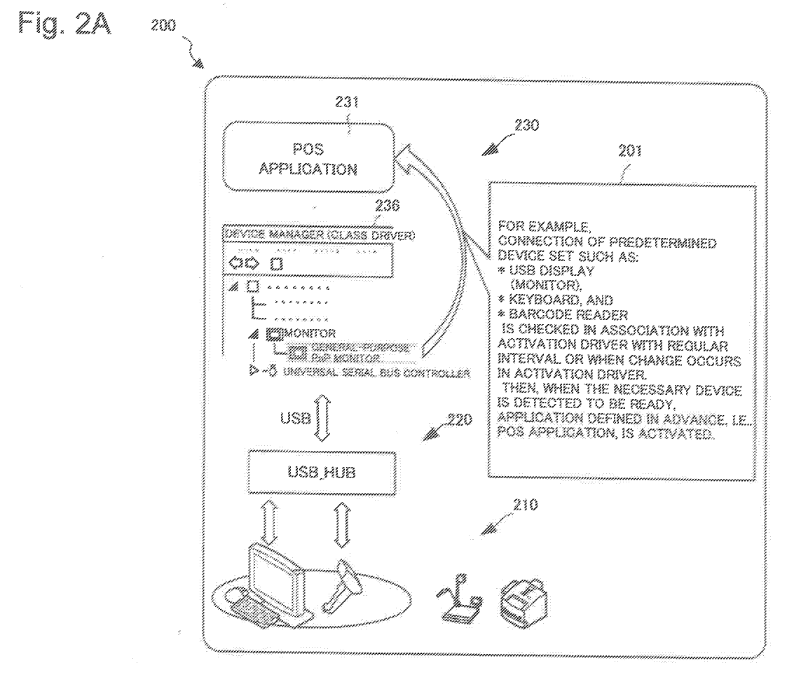

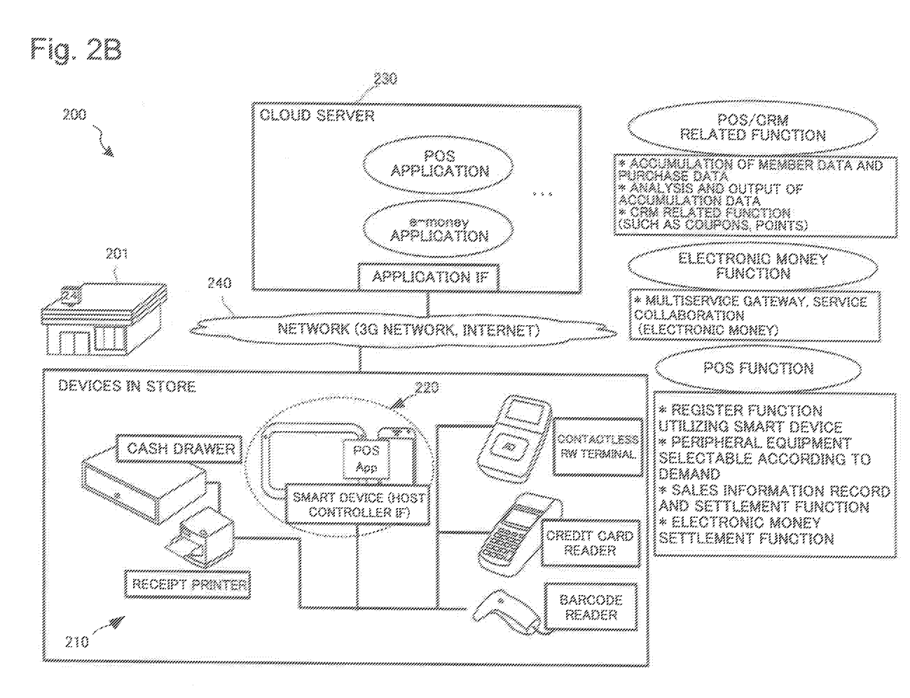

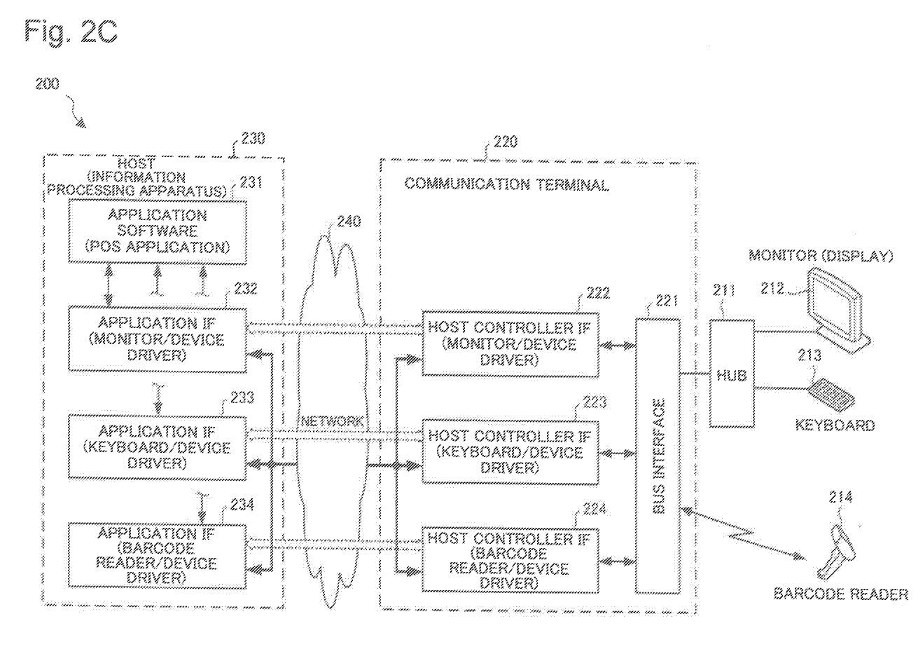

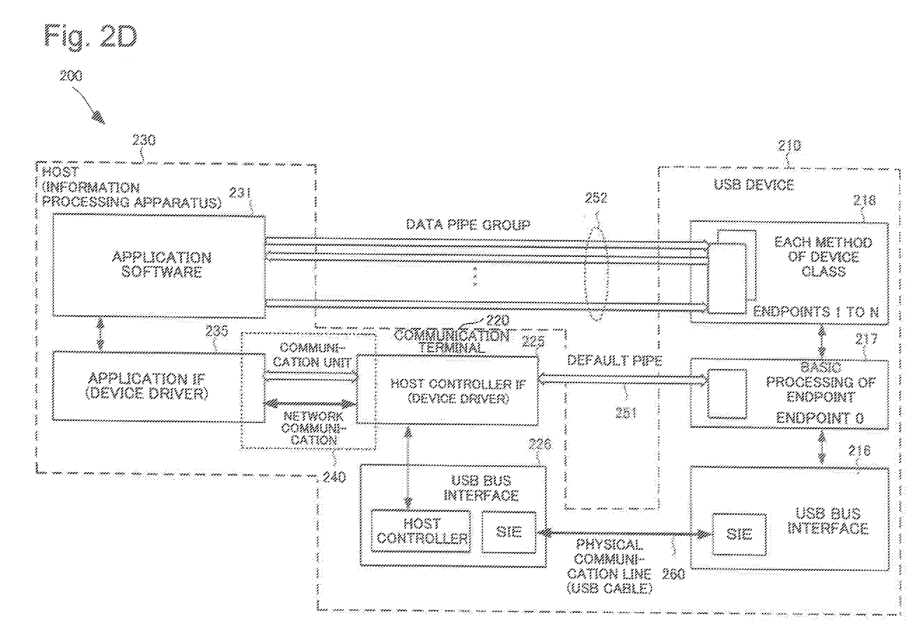

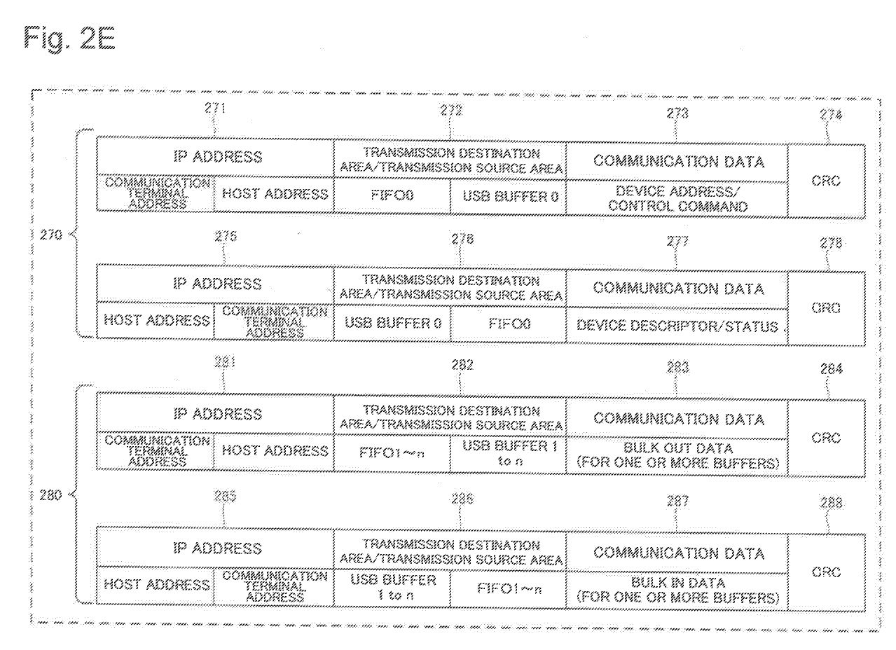

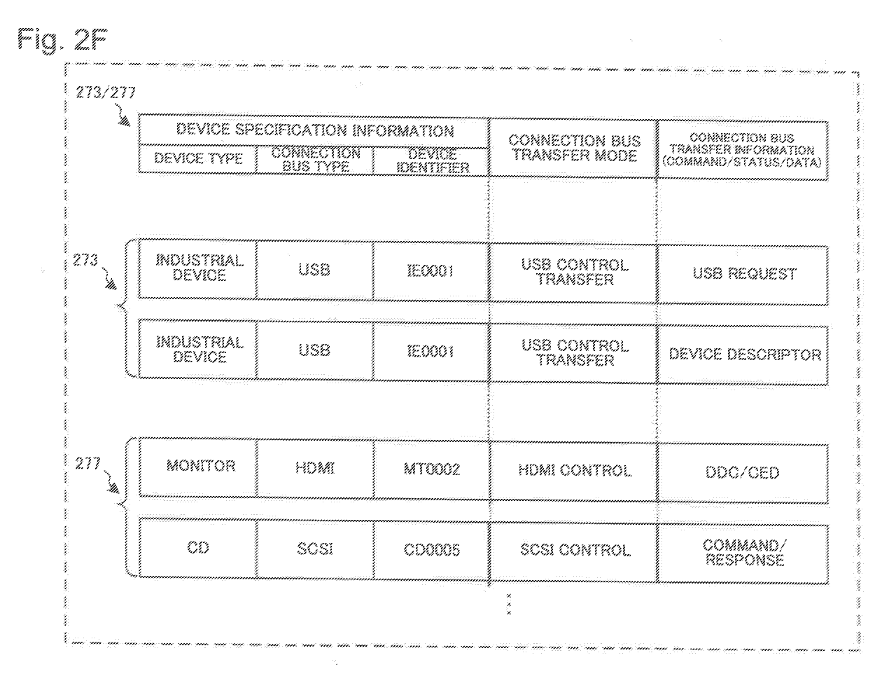

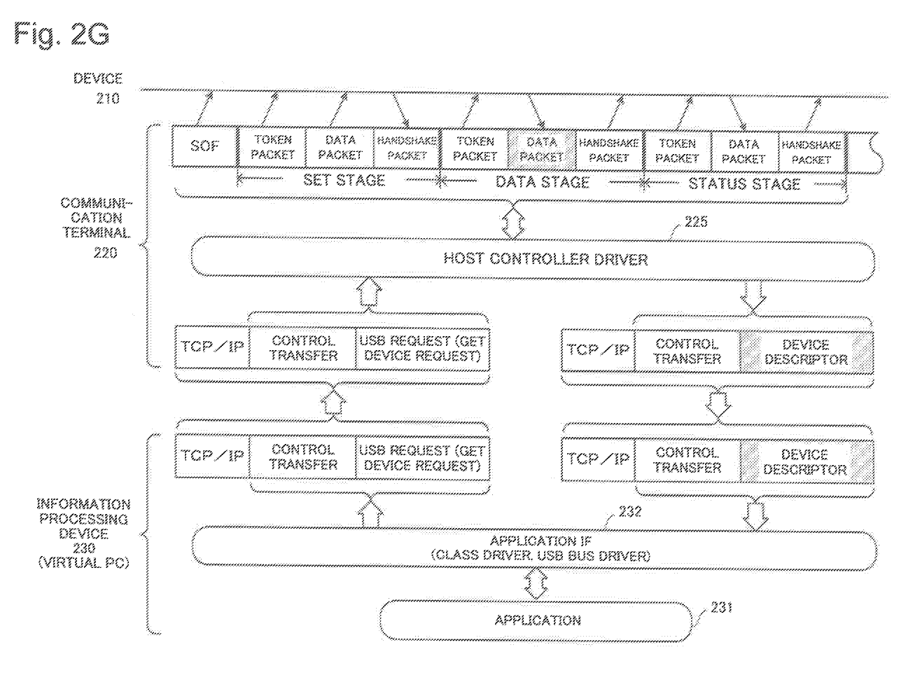

FIG. 2A is a figure illustrating an operation of an information processing system 200 including an information processing device and a remote device according to the present example embodiment.

The information processing system 200 includes an information processing device 230 executing a POS application (a POS application in the figure) 231, a communication terminal 220 is communicatively connected to the information processing device 230, and a device 210 connected to the communication terminal 220 via a bus. The information processing device 230 uses a device manager 236 to manage a directly connected device and a device remotely connected via the communication terminal 220. A device remotely connected via the communication terminal 220 is preferably controlled by a device driver that operates in a cooperative manner with the information processing device 230 and the communication terminal 220.

When the management screen of the connection devices is displayed by the device manager 236 in the information processing device 230 of FIG. 2A, a directly connected device and a device remotely connected via the communication terminal 220 are displayed in a similar manner and can be selected. The information processing device 230 in FIG. 2A may be a desktop PC (Personal Computer), a laptop computer, or a virtual PC structured in a cloud server.

In the information processing system 200, as described in a comment 201, for example, a connection of a predetermined device set such as a USB display (monitor), a keyboard, and a barcode reader is checked in association with an activation driver with a regular interval or when a change occurs in the activation driver. Then, when a needed device is detected to be connected, an application defined in advance, i.e., the POS application 231 in this example, is activated.

FIG. 2B is a figure illustrating a configuration of the information processing system 200 according to the present example embodiment. FIG. 2B shows an example of a store POS when the information processing device 230 is a virtual PC structured in the cloud server and the communication terminal 220 is a smart device such as smartphone or tablet.

The information processing system 200 includes an information processing device 230 as a cloud server, a communication terminal 220 as a smart device arranged in a shop 201, a network 240 including 3G network and the internet connecting the information processing device 230 and the communication terminal 220, and a device 210 connected to the communication terminal 220 via a has. In the present example embodiment, the information processing device 230 executes an application that processes a POS system such as a POS application and an electronic money (e-money) application. The information processing device 230 executes, in a distributed manner, an application interface portion of the device driver controlling the device connected to the communication terminal 220.

The communication terminal 220 is connected, via a bus, to not only a display, a keyboard, and a pointing device (not shown), which are devices for realizing the POS system, but also a cash drawer, a receipt printer, a barcode reader, a credit card reader, a contactless RW terminal, and the like. The communication terminal 220 executes, in a distributed manner, a host controller interface portion of the device driver controlling each of the connected device. The device driver is configured while the application interface portion of the information processing device 230 and the host controller interface portion of the communication terminal 220 communicate.

In the present information processing system, accumulation of member data and purchase data, analysis and output of accumulation data, CRM related function (coupons, points, and the like) are executed as POS/CRM (Customer Relationship Management) related function. Multiservice gateway or service collaboration (electronic money) which is an electronic money function is executed. A register function utilizing a smart device, peripheral equipment selectable according to demand, sales information record and settlement function, electronic money settlement function, and the like are executed as POS function.

In the present example embodiment, for example, the middleware of the information processing device 230 checks the device driver which is activated for the device connected to the communication terminal 220 which is a smart device. On the basis of the check result, an application that can be executed with the connected and usable device is activated. In this case, updating and stopping of the application are controlled in accordance with an increase or a decrease in connected and usable devices. More specifically, when the number of connected and usable devices increases, a new application that executes an executable function is activated, and the function of the application being executed is additionally executed. When the number of connected and usable devices decreases, the application that has become inexecutable is terminated, or the inexecutable function of the application being executed is stopped.

FIG. 2C is a figure illustrating a concept of the information processing system 200 according to the present example embodiment. FIG. 2C illustrates a configuration of a device driver between the information processing device 230 and the communication terminal 220 according to the present example embodiment.

FIG. 2C illustrates a state in which a display 212 as a monitor, a keyboard 213 for inputs and instructions, and a barcode reader 214 for reading commodity information, which are minimum devices to activate the POS application, are connected to the communication terminal 220, and each device driver has been activated. The display 212 and the keyboard 213 are connected to the bus interface 221 of the communication terminal 220 via the hub 211, the barcode reader 214 is connected to the bus interface 221 of the communication terminal 220.

As the monitor device driver for controlling the display 212, the host controller interface 222 of the communication terminal 220 and the application interface 232 of the information processing device 230 are activated. A pipe is established via the network 240 between the host controller interface 222 and the application interface 232. As the keyboard device driver for controlling the keyboard 213, the host controller interface 223 of the communication terminal 220 and the application interface 233 of the information processing device 230 are activated. A pipe is established via the network 240 between the host controller interface 223 and the application interface 233. As the barcode reader device driver for controlling the barcode reader 214, the host controller interface 224 of the communication terminal 220 and the application Interface 234 of the information processing device 230 are activated. A pipe is established via the network 240 between the host controller interface 224 and the application interface 234.

The information processing device 230 cheeks whether application interfaces 232 to 234 have been activated, and when the monitor, the keyboard, and the barcode reader are determined to be usable, the POS application 231 is activated as the application software. When the monitor, the keyboard, and the barcode reader are usable, the POS application 231 is activated, but among the functions, price setting processing based on discount price tag of a commodity can be executed. When, for example, the cache drawer and the receipt printer are determined to be usable, cash settlement processing in the POS application 231 can be executed. When the credit card reader is determined to be usable, credit settlement processing of the POS application 231 can be executed. When the contactless RW terminal is determined to be usable, electronic money settlement processing of the POS application 231 can be executed.

In this way, the functions of the same POS application 231 may be configured to be executable in a step by step manner with the device set, or a different POS application may be configured to be activated with the device set.

FIG. 2D is a figure illustrating a device connection of the information processing system 200 according to the present example embodiment. FIG. 2D is a figure illustrating how a control pipe (default pipe) and a data pipe are established among the host (information processing device) 230, the communication terminal 220, and the USB device 210. In FIG. 2D, OS (Operating System) and BIOS (Basic input and Output System) which are regular software are not shown.

The information processing system 200 in FIG. 2D includes a host 230 as an information processing device, a communication terminal 220 which is remotely located and connected to a host 230 via a network 240, and a USB device 210 connected to the USB connector of the communication terminal 220.

The host 230 has application software 231 as software, and an application interface (application IF in the figure) 235 as a part of the device driver. The application software 231 is software for providing a service provided by the host 230 in advance or a service developed by the user in advance. The application interface 235 interprets a structure of input and output file operation requested by the application software 231, and generates a structure that defines control information and data to be transmitted and received via the network 240 according to the target device of the input and output file operation, its protocol, data format, and the like. In this example, since it is an access of an input and output file to the USB device 210, transmission and reception of a command according to the protocol of USB and data based on the data format are prepared.

The communication terminal 220 includes, as software, a host controller interface (host controller IF in the figure) 225 which is a part of the device driver and a USB bus interface 226 having a host controller and an SIE, the host controller interface 225 receives commands, data, and she like according to the USB protocol from the application interface 235 via the network 240, and gives the received command, data, and the like in a format that can be understood by the host controller of the USB bus interface 226, the host controller interface 225 transmits the data, the device stains, and the like received from the host controller of the USB bus interface 226 via the network 240 to the application interface 235 via the network 240. The host controller of the USB bus interface 226 executes serial communication via the USB cable 260 in accordance with the USB protocol while exchanging commands, data and the like with the host controller interface 225. The SIE of the USB bus interface 226 controls the signal on the USB cable 260 according to the USB communication standard.

The USB device 210 has, as software, a USB bus interface 216 of the USB device 210 that connects and exchanges signals with the USB bus interface 226 of the communication terminal 220 via the USB cable 260. The USB device 210 includes an end point 0217 consisting of FIFO (First-in First-out) 0 for storing descriptors including device information and control information, and end points 1 to n 218 including FIFOs 1 to n storing input and output data.

With such a connection, the communication terminal 220 and the USB device 210 execute the physical level communication with the USB bus interfaces 226, 216 of each other. Control communication as basic processing is realized between the application software 231 and the end point 0217 via the default pipe 251 with the system level control transfer via the application interface 235, the network 240, and the host controller interface 225. In data transfer at the application level, data communication is realized as each method of the device class between the application software 231 and the end points 1 to n 218 via the data pipe group 252.

As described above, a unified communication channel (pipe) can be formed by the network communication between the application interface 235 of the host 230 and the host controller interface 225 of the communication terminal 220 via the network 240 and the serial communication between the USB bus interfaces 226 and 216 via the USB cable.

### (Communication Message)

FIG. 2E is a figure illustrating a configuration of a communication message according to the present example embodiment. It should be noted that the format of the communication message is not limited to FIG. 2E.

FIG. 2E illustrates control messages 270 transmitted and received in the control channel which is the default pipe 251 and data messages 280 transmitted and received in the data channel serving as the data pipe group 252.

Among the control message 270, a control message sent from the host 230 to the communication terminal 220 includes an IF address 271, a transmission destination area and transmission source area 272, communication data 273, and for example, CRC 274 for error correction. The communication terminal address of the transmission destination and the host address of the transmission source are set as the IP address 271. As the transmission destination area and transmission source area 272, FIFO 0 of the USB device 210 is instructed in the transmission destination area, and USB buffer 0 of the host 230 is instructed in the transmission source area. As the communication data 273, the device address assigned by the host 230 and the control command of the USB device 210 are transmitted.

Among the control message 270, a control message sent from the communication terminal 220 to the host 230 includes an IP address 275, a transmission destination area and transmission source area 276, communication data 277, and for example, CRC 278 for error correction. As the IP address 275, the host address of the transmission destination and the communication terminal address of the transmission source are set. As the transmission destination area and transmission source area 276, USB buffer 0 of the host 230 is instructed in the transmission destination area, and FIFO 0 of the USB device 210 is instructed in the transmission source area. As the communication data 277, the device descriptor and the device status of the USB device 210 are transmitted.

Among the data message 280, a data message sent from the host 230 to the communication terminal 220 includes an IP address 281, a transmission destination area and transmission source area 282, communication data 283, and for example, CRC 284 for error correction. As the IP address 281, the communication terminal address of the transmission destination and the host address of the transmission source are set. As the transmission destination area and transmission source area 282, FIFOs 1 to n of the USB device 210 are instructed in the transmission destination area in an associated manner, and USB buffers 1 to n of the host 230 are instructed in the transmission source area in an associated manner. As the communication data 283, one or more pieces of bulk OUT data are transmitted.

Among the data messages 280, a data message sent from the communication terminal 220 to the host 230 includes an IP address 285, a transmission destination area and transmission source area 286, a communication data 287, and for example, CRC 288 for error correction. As the IP address 285, the host address of the transmission destination and the communication terminal address of the transmission source are set. As the transmission destination area and transmission source area 286, the USB buffers 1 to n of the host 230 are instructed in the transmission destination area in an associated manner, and FIFOs 1 to n of the USB device 210 are instructed in the transmission source area in an associated manner. As the communication data 287, one or more pieces of bulk IN data are transmitted.

Besides control transfer and balk transfer, there are interrupt transfer and isochronous transfer, but as the configuration of the data message, the “SETUP” stage is omitted, but it is similar to the above, so those messages will not be explained.

In this manner, the encapsulated IP address is the network communication between the host 230 and the communication terminal 220, but data is transmitted between the USB buffer allocated by the application software 231 in the host 230 and the FIFO which is the end point of the USB device 210.

### (Example of Configuration of Communication Data)

FIG. 2F is a figure illustrating a configuration of communication data according to the present example embodiment. FIG. 2F does not show any IP address for encapsulation in FIG. 2E. FIG. 2F shows an example of configuration of the communication data for realizing the present example embodiment, but the present embodiment is not limited thereto. For example, parameters (arguments) of a function, and the function itself, and the like can be transmitted and received as communication data in the upper layer of the device driver.

FIG. 2F illustrates basic communication data configuration 273/277, communication data configuration 273 for the case of USB, and a communication data configuration 277 for the case of other HDMI® and SCSI.

The communication data configuration 273/277 includes device identifying information. The device identifying information includes a device type, a connection bus type, and a device identifier. The communication data configuration 273/277 includes a transfer mode in the connection bus and information to be transferred via the connection bus. Information to be transferred includes a command, a status, and data.

The communication data configuration 273 in the case of the USB includes, as device identifying information, an industrial device which is a device type, USB which is a connection bus, and IE 001 which is a device identifier. The communication data configuration 273 in the case of USB includes USB control transfer as a transfer mode and a USB request and a device descriptor as transfer information. According to such a configuration, it is not necessary to consider the limitation of 127 devices at maximum based on the conventional USB connection.

The communication data configuration 277 for the case of other HDMI® and SCSI includes, as device identifying information, a monitor, HDMI®, MT00G2, CD, SCSI, and CD0005. The communication data configuration 277 for the case of other HDMI® and SCSI also includes HDMI® control as transfer mode 2 and DDC/CED and command/response as SCSI control, transfer information.

### (Example of Data Transmission)

FIG. 2G is a figure illustrating data transmission in the information processing system 200 according to the present example embodiment. FIG. 2G shows L2 level communication in the USB device, but the communication may be performed at a lower level or a higher level.

FIG. 2G is a sequence diagram showing descriptor acquisition procedure of the USB device connected with USB.

The descriptor set in the device 210 is acquired by a USB request such as GET_DESCRIPTOR. The USB request is exchanged with the device 210 in each of the control transfers. Each control transfer includes set stage, data stage, and status stage. Each stage includes a token packet, a data packet, and a handshake packet. The descriptor is obtained in a data packet of each data stage. The descriptor obtained from the device 210 is IP-encapsulated with an IP header and a TCP header and transmitted from the USB hub 221 constituted by a mobile terminal to the information processing device 230.

In this case, in accordance with the device input and output request of the application 231, first, the class driver 232 and the bus driver constituting the application interface of the information processing device 230 generates control transfer and a USB request of GET DESCRIPTOR, to confirm the connection device, and send the control transfer and the USB request to the communication control unit.

The control transfer and the USB request of GET DESCRIPTOR which are IP-encapsulated with the IP header and the TCP header are received and IP-decapsulated by the communication control unit of the USB hub 221 constituted by the communication terminal. The control transfer and the USB request of GET DESCRIPTOR are sent to the host controller driver 225. The host controller driver 225 instructs a USB bus interface (not shown) to generate each packet in the USB bus to the device 210 based on the control transfer and the USB request of the GET DESCRIPTOR.

The host controller driver 225 extracts, as a device descriptor, the data packet received from the device 210 and received in the data stage, and sends it to the communication control unit as control transfer and device descriptor. The control transfer and the device descriptor IP-encapsulated with the IP header and the TCP header are transmitted from the communication control unit of the USB hub 221 constituted of the communication terminal to the communication control unit of the information processing device 230.

When the communication control unit of the information processing device sends the decapsulated control transfer and device descriptor to the bus driver and the class driver 232 constituting the application interface, the class driver 232 notifies the connection device information in response to the device input and output request of the application 231.

Similar data transmission is performed in other control transfer, bulk transfer, interrupt transfer, and isochronous transfer as well. It may be software in which the host controller driver 225 and the USB bus interface 226 are integrated.

### <<Software Configurations>>

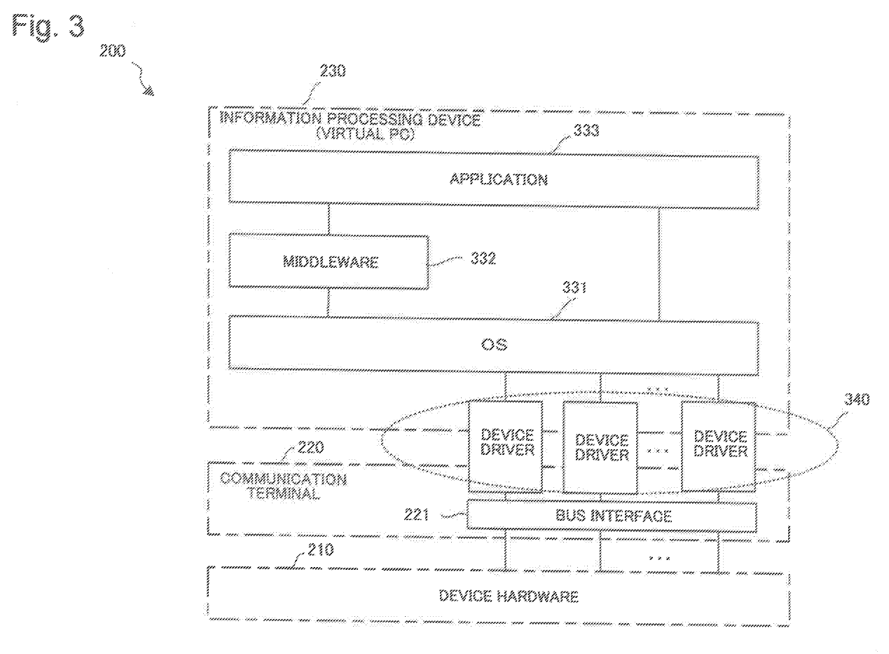

FIG. 3 is a figure illustrating a configuration of software of the information processing system 200 according to the present example embodiment. FIG. 3 shows the outline of the software configuration according to the present example embodiment, and detailed configuration will not be shown.

The virtual PC structured in the information processing device 230 executes an application 333, middleware 332, an OS 331, and the application interface of each device driver 340. The communication terminal 220 executes a host controller interface of each device driver 340 and a bus interface 221 which performs bus control to the device hardware 210. In this case, the middleware 332 performs control including start, stop, monitoring, and the like of each application including application management software executing control between the application 333 and the OS 331 such as those controlling application activation according to the present example embodiment. The middleware 332 also includes database management software, transaction monitor software, and the like.

### <<Function Configuration of Information Processing Device>>

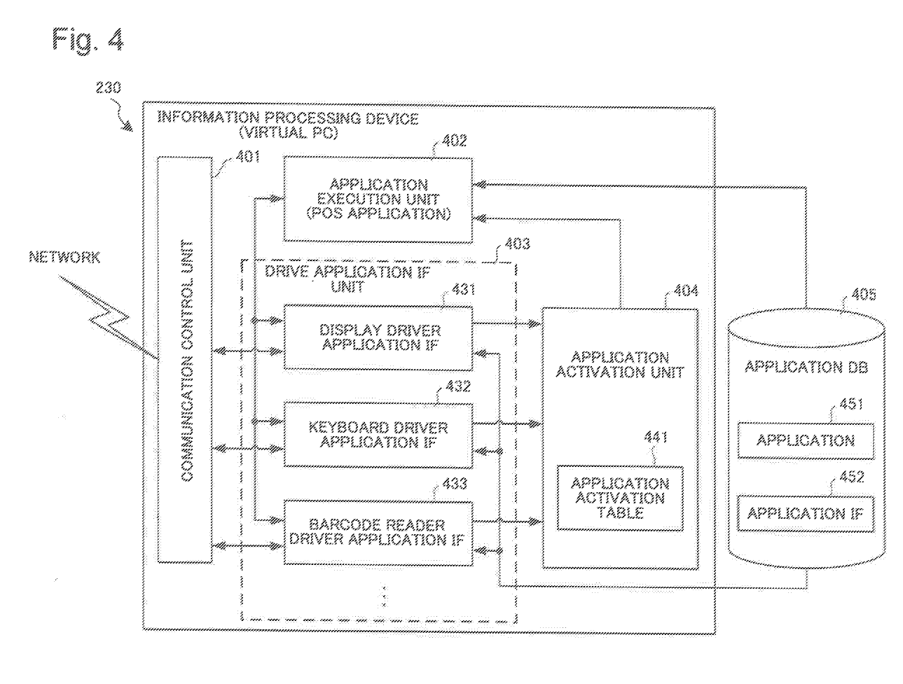

FIG. 4 is a block diagram illustrating a configuration of functions of the information processing device 230 according to the present example embodiment. FIG. 4 illustrates function constituting units deeply associated with operation of the present example embodiment. Ordinary function constituting units possessed by the information processing device 230 are not shown. For example, various processing functions in the case where the information processing device 230 is a PC are not shown.

The information processing device 230 includes a communication control unit 401, an application execution unit 402, a drive application interface unit 403, and an application activation unit 404. An application database (application DB in the figure) 405 is provided outside or inside the information processing device 230. The application database 405 stores a plurality of applications 451 and a plurality of application interfaces 452 which is a part of the device driver.

The communication control unit 401 controls communication with the communication terminal 220 via the network 240. The application execution unit 402 executes the application stored in the application database 405 according to the instruction of the application activation unit 404. FIG. 4 shows an example where the POS application is being executed. The drive application interface unit 403 searches the application database 405 for an application interface and executes the application interface implementing the input and output file operation related to the device connected to the communication terminal 220. FIG. 4 illustrates an example in which the display driver application interface 431, the keyboard driver application interface 432, and the barcode reader driver application interface 433 are operating. The application activation unit 404 checks the operating application interface from the drive application interface unit 403, selects the application to be activated based on an application activation table 441, and instructs the application execution unit 402 to execute to the application.

The display driver application interface 431, the keyboard driver application interface 432, and the barcode reader driver application interface 433 constitute each device driver in cooperation with a display driver host controller interface 521, a keyboard driver host controller interface 522, and a barcode reader driver host controller interface 523, respectively, of the communication terminal 220.

### <<Configuration of Functions of Communication Terminal>>

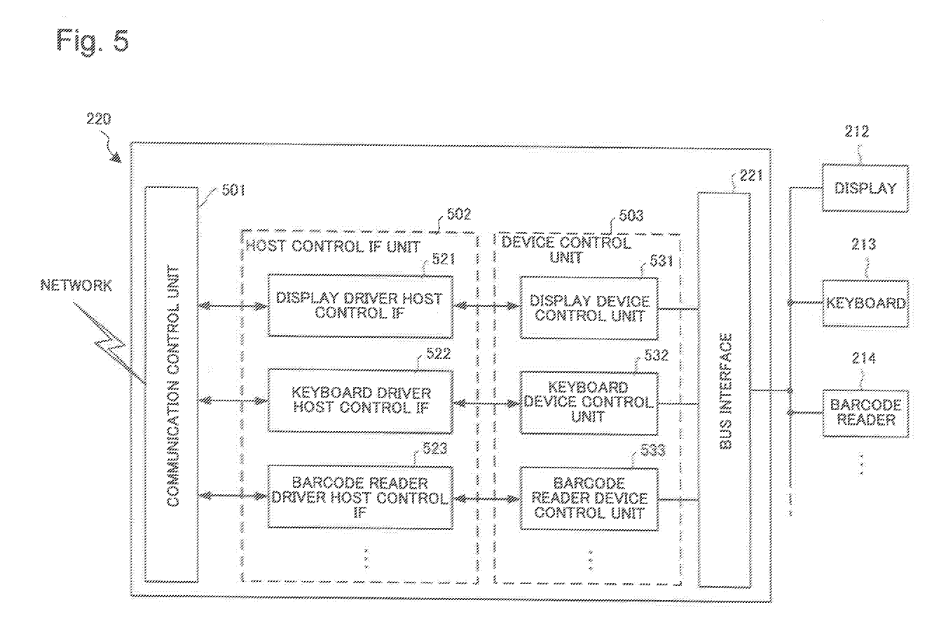

FIG. 5 is a block diagram illustrating a configuration of functions of a communication terminal according to the present example embodiment. FIG. 5 illustrates function constituting units deeply associated with the operation according to the present example embodiment, but FIG. 5 does not show ordinary function constituting units possessed by the communication terminal 220. For example, various processing functions in the case where the communication terminal 220 is a smartphone or a tablet are not shown.

The communication terminal 220 includes a communication control unit 501, a host controller interface unit 502, a device control unit 503, and a bus interface 221.

The communication control unit 501 controls communication with the information processing device 230 via the network 240, the host control interface unit 502 executes the host controller interface for realizing the input and output file operation related to the connected device. FIG. 5 illustrates an example where the display driver host control interface 521, the keyboard driver host control interface 522, and the barcode reader driver host control interface 523 are operating. The display driver host controller interface 521, the keyboard driver host controller interface 522, and the barcode reader driver host controller interface 523 constitute each device driver in cooperation with the display driver application interface 431, the keyboard driver application interface 432, and the barcode reader driver application interface 433, respectively, of the information processing device 230.

The device control unit 503 controls the device related to the connection bus of each device. FIG. 5 illustrates an example where a display device control unit 531, a keyboard device control unit 532, and a barcode reader device control unit 533 are operating. The bus interface 221 controls bus communication with the display 212, the keyboard 213, and the barcode reader 214 winch are the devices.

### (Application Activation Table)

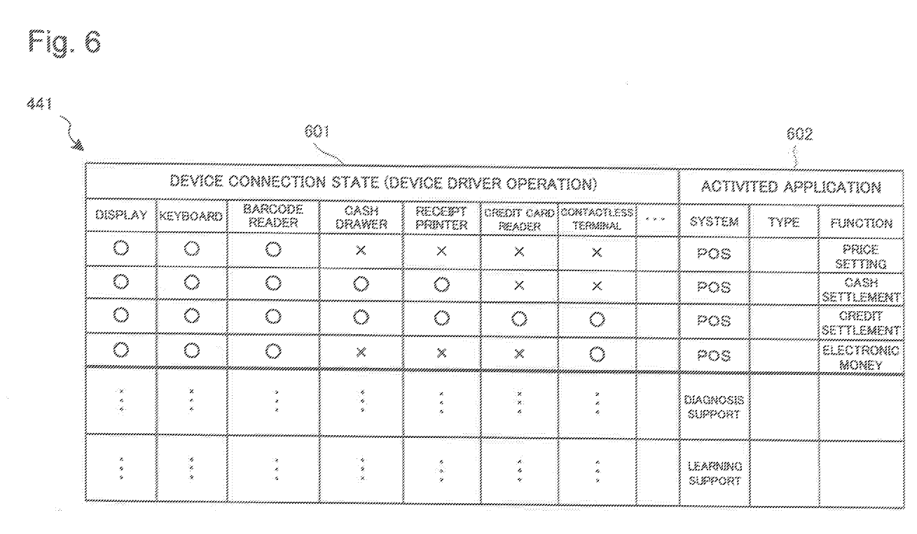

FIG. 6 is a figure illustrating a configuration of the application activation table 441 according to the present example embodiment. The application activation table 441 is used by the application activation unit 404 in order to check whether the device is usable from the activation of the device driver and select and activate the application related to the usable device.

The application activation table 441 stores a device connection state 601 for determining whether the device can be used from the operation of the device driver and an activated application 602 related to the device connection state 601. The device connection state 601 stores connection states of, for example, a display, a keyboard, a barcode reader, a cash drawer, a receipt printer, a credit card reader, a contactless terminal, and the like in the POS system according to the present example embodiment. In FIG. 6, O indicates “connected and usable”, and x indicates “unusable”. The activated application 602 stores a POS application, a type thereof, and a function thereof. The activated application 602 may store the function to select an execution function of the same POS application, or different functions with different POS applications.

FIG. 6 shows the details of the configuration of the application activation table 441 of the POS system of interest according to the present example embodiment, but a similar application activation table can be generated for, e.g., applications of a diagnosis support system, applications of a learning support system, and the like, and the application activation control can achieve effects similar to those of the present example embodiment.

<<Hardware Configuration of Information Processing Device>>

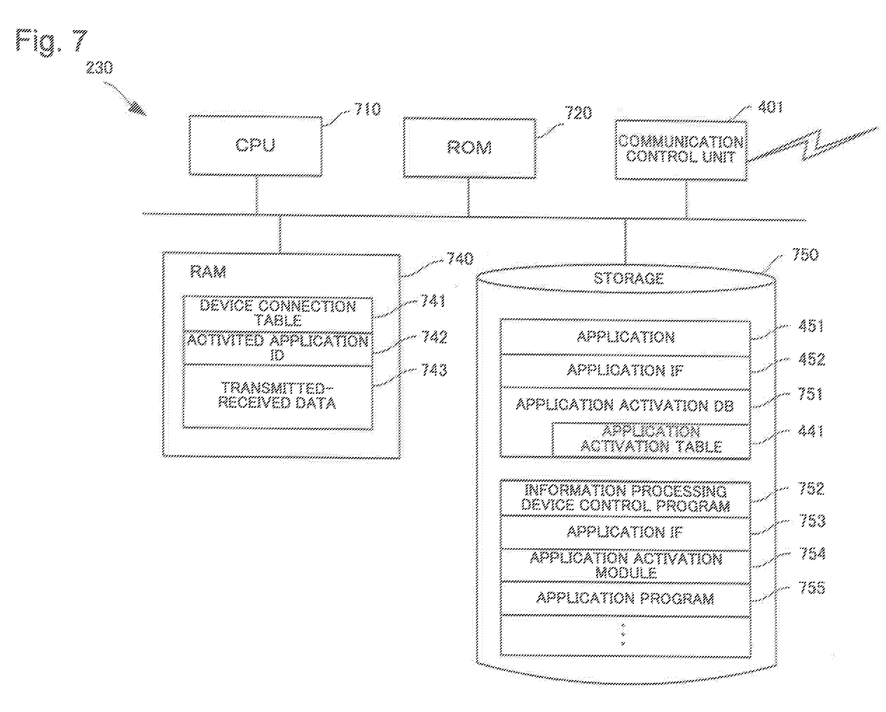

FIG. 7 is a block diagram illustrating a configuration of hardware of the information processing device 230 according to the present example embodiment. In FIG. 7, the information processing device 230 is shown as an actual PC, but the information processing device 230 may be a virtual PC structured in a cloud server.

In FIG. 7, a CPU (Central Processing Unit) 710 is a processor for computation control, and the CPU executes a program to realize the function constituting unit of the information processing device 230 of FIG. 4. An ROM (Read Only Memory) 720 stores fixed data and programs such as initial data and programs. The communication control unit 401 communicates with the communication terminal 220 via the network 240. The number of CPUs 710 is not limited to one, and there may be a plurality of CPUs or a GPU for image processing may be included. The communication control unit 401 preferably has a CPU independent from the CPU 710 to write or read the transmission and reception data in an area of a RAM (Random Access Memory) 740. It is desirable to provide a DMAC (not shown) that transfers data between the RAM 740 and the storage 750. Therefore, the CPU 710 recognizes that data has been received or transferred to the RAM 740 and processes data. The CPU 710 prepares the processing result in the RAM 740, and allows the communication control unit 401 or the DMAC to perform subsequent transmission or transfer.

The RAM 740 is a random access memory used by the CPU 710 as a work area for temporary storage. An area for storing data required for realizing the present example embodiment is reserved in the RAM 740. The device connection table 741 determines and stores a connected and usable device from whether the device driver is activated. The activated application ID 742 stores the identifier (ID) of the activated application selected by referring to the application activation table 441 based on the content of the device connection table 741. The transmission and reception data 743 is data to be transmitted and received with the device 210 connected to the communication terminal 220 and the communication terminal 220 via the communication control unit 401.

The storage 750 stores databases and various parameters, or the following data or programs required to realize the present example embodiment. The application 451 is searchable application software provided by the information processing device 230. The application interface 452 is a part of the device driver provided by the information processing device 230 in relation to the device. The application activation database 751 is a database that accumulates the relationship between the device set that is connected for utilizing and the application to activate. The application activation table 441 is a part of the application activation database 751, and may be set by the user or may be generated through learning based on the data accumulated in the application activation database 751.

The storage 750 stores the following programs. The information processing device control program 752 is a program that controls the entire information processing device 230 of the present embodiment. The application interface 753 is a part of each device driver that activated. The application activation module 754 is a module as middleware that selects an application and instructs the application to activate based on the device connection table 741 and the application activation database 751. The application program 755 is an application selected and activated by the application activation module 754.

In the RAM 740 and the storage 750 of FIG. 7, the programs and the data associated with the general-purpose functions of the information processing device 230 and other feasible functions are not illustrated.

### <<Processing Procedure of Information Processing Device>>

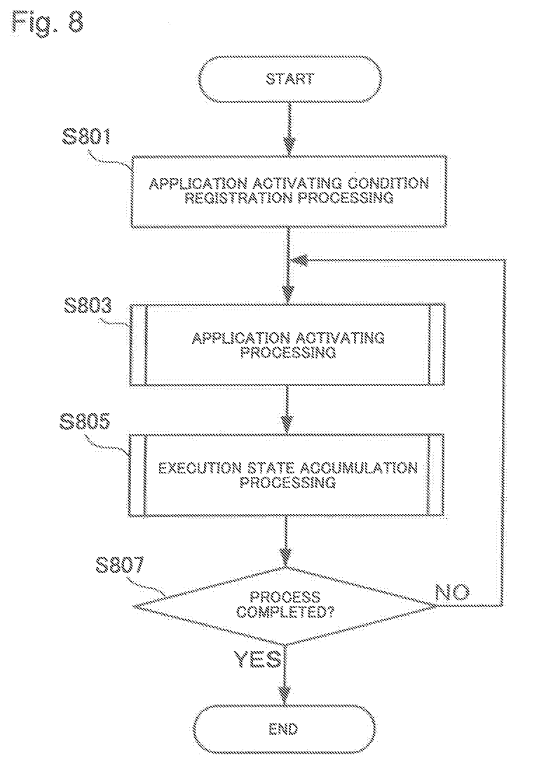

FIG. 8 is a flowchart illustrating a procedure of processing of the information processing device 230 according to the present example embodiment. This flowchart is executed by the CPU 710 in FIG. 7 using the RAM 740 and the function constituting unit in FIG. 4 is realized.

In step S801, the information processing device 230 registers an application activation condition in the application activation database 751. This registration may be an input of a device set and an activating application by the user, or a device set and an activating application generated through learning from the past history. In step S803, the information processing device 230 executes application activation processing according to the application activation table 441. In step S805, the information processing device 230 accumulates the execution state of the application. Then, in step S807, the information processing device 230 determines whether the application processing is to be terminated. If the application processing is not to be terminated, the process of the information processing device 230 returns to step S803 to perform activation processing of a subsequent application.

### (Application Activation Processing)

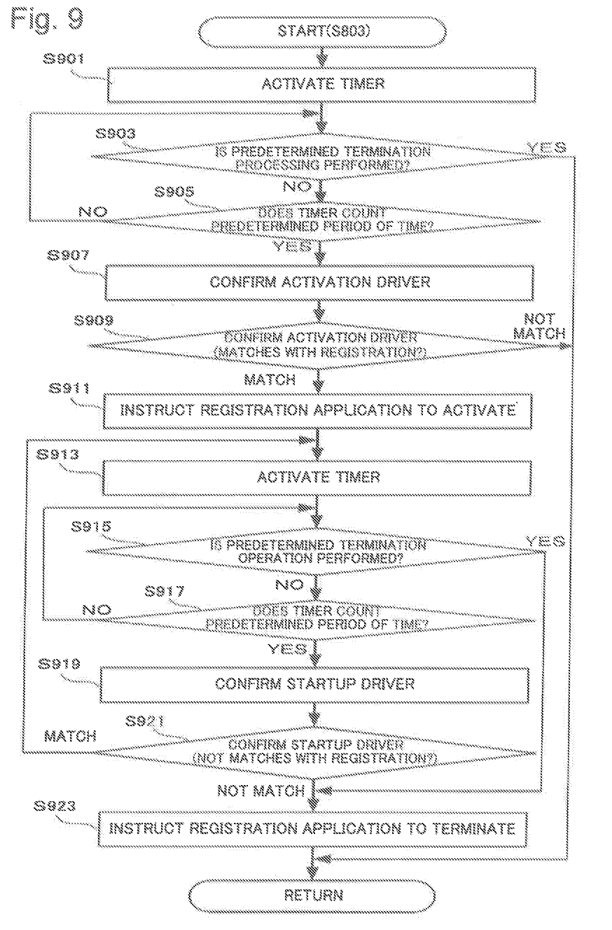

FIG. 9 is a flowchart illustrating a procedure of application activation processing (S803) according to the present example embodiment.

In step S901, the information processing device 230 activates a timer that counts the time for checking the device driver that has been activated. In step S903, the information processing device 230 determines whether predetermined termination processing has been performed. If there is termination processing, the processing is terminated and the process proceeds to “return”.

If there is no termination, processing, the information processing device 230 determines whether the timer has counted the predetermined period of time in step S905. If the timer has not counted the predetermined period of time, the process of the information processing device 230 returns to step S903 to continue time counting for confirming the device driver that has been activated.

When the tinier has counted the predetermined period of time, the information processing device 230 confirms, as the connected device, the device driver that has been activated in step S907. Then, in step S909, the information processing device 230 determines whether the device driver that has been activated matches with the activation device registered in step S801. When the device driver that has been activated does not match with the activation device registered in step S801, it is assumed that a needed device is not connected or usable, and the processing is terminated and the processes are returned.

When the device driver that has been activated matches with the activation device registered in step S801, the information processing device 230 selects the application registered in step S801 in relation to the matching activation device and instructs the application to activate in step S911. Therefore, the application is activated up by selection of such application and the activation instruction.

In step S913, the information processing device 230 activates a timer that counts the time to check the device driver that has been activated. The time counted by the timer may be the same as or different from that in step S901. In step S91S, the information processing device 230 determines whether predetermined termination processing has been performed. If there is termination processing, the information processing device 230 instructs, in step S923, termination of the application that is instructed to activate in step S911.

If there is no termination processing, the information processing device 230 determines whether the timer has counted the predetermined period of time in step S917. If the timer has not counted the predetermined period of time, the process of the information processing device 230 returns to step S915 and time counting for confirming the device driver that has been activated is continued.

When the timer has counted the predetermined period of time, the information processing device 230 confirms, as the connected device, the device driver that has been activated in step S919. Then, in step S921, the information processing device 230 determines whether the device driver that has been activated matches with the activation device registered in step S801. When the device driver that has been activated does not match with the activation device registered in step S801, it is assumed that the needed device is disconnected or in an unusable state, and the information processing device 230 gives, in step S923, a termination instruction of the application instructed to activate in step S911.

When the device driver that has been activated matches with the activation device registered in step S801, the process of the information processing device 230 returns to step S913 again and the processing for confirming the activation driver after the timer has counted the time is continued.

The flowchart in FIG. 9 shows the case where an application is activated or terminated according to an activation device. However, different applications may be activated in relation to an increment and decrement of activation devices, or an execution function may be selected in the same application in relation to an increment and decrement of activation devices. These flowcharts are complicated, so details are omitted here, but they can be easily created.

According to the present example embodiment, a POS application using a desired POS device can be activated stably by determining the activation of the device drive for the remote POS device.

### Third Example Embodiment

Subsequently, an information processing system according to the third example embodiment of the present invention will be explained. The information processing system according to the present example embodiment differs from the above second example embodiment in that the activation application is selected in relation to the user. Since the other configuration and operation are similar to those of the second example embodiment, the same configuration and operation will be denoted with the same reference numerals, and the detailed explanation thereabout is omitted.

### <<Information Processing System>>

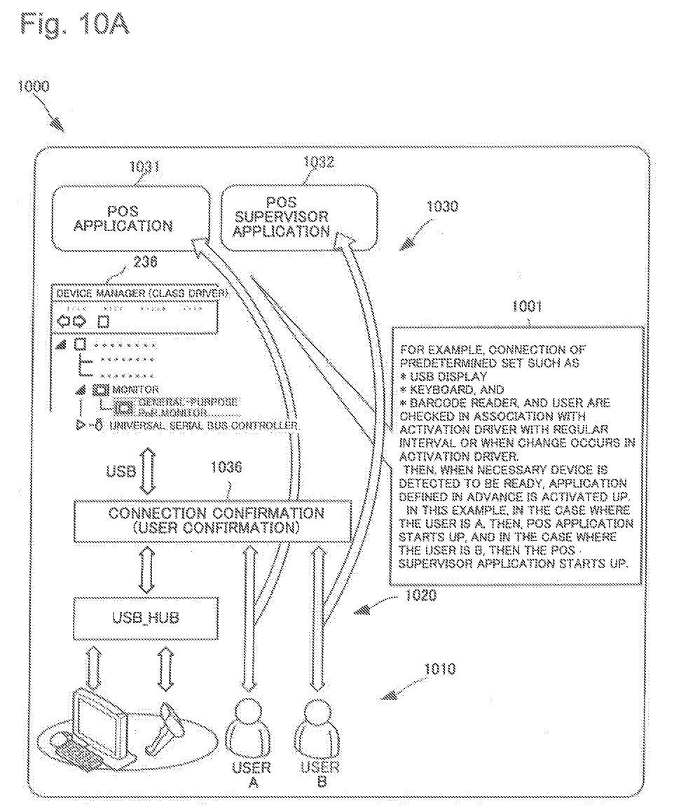

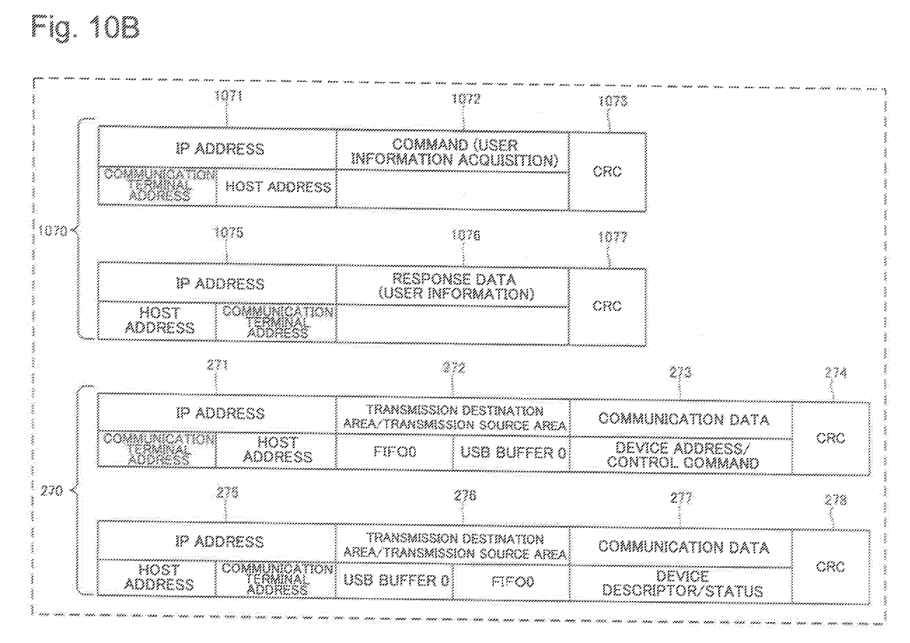

FIG. 10A is a figure illustrating an operation of an information processing system 1000 including an information processing device and a remote device according to the present example embodiment. In FIG. 10A, the same reference numerals are denoted to similar constituent elements as those in FIG. 2A.

The information processing system 1000 includes an information processing device 1030 which confirms the user in a connection confirmation 1036, and executes a POS application (POS application in the figure) 1031 or a POS supervisor application (POS supervisor application in the figure) 1032 related to the user. The information processing system 1000 includes a communication terminal 1020 communicatively connected to the information processing device 1030 and a device 1010 connected to the communication terminal 1020 via a bus. The information processing device 1030 uses a device manager 236 to manage a directly connected device and a device remotely connected via the communication terminal 1020. A device remotely connected via the communication terminal 1020 is preferably controlled by a device driver that operates in a cooperative manner with the information processing device 1030 and the communication terminal 1020.

When the management screen of the connection devices is displayed by the device manager 236 in the information processing device 1030 of FIG. 10A, a directly connected device and a device remotely connected via the communication terminal 1020 are displayed in a similar manner and can be selected. The information processing device 1030 in FIG. 10A may be a desktop PC (Personal Computer) and a laptop computer, or a virtual PC structured in a cloud server.

In the information processing system 1000, as described in a comment 1001, for example, a connection of a predetermined device set such as a USB display (monitor), a keyboard, and a barcode reader, and the user of the application to be activated are cheeked in relation to an activation driver with a regular interval or when a change occurs in the activation driver. Then, when a needed device is detected to be ready, an application defined in advance in relation to the user is activated. In this example, in the case where the user is an employee, i.e., user A, then, the normal POS application 1031 activates, and in the case where the user is a manager, i.e., user B, then the POS supervisor application 1032 activates.

### (Communication Message)

FIG. 10B is a figure illustrating a configuration of a communication message according to the present example embodiment. It should be noted that the format of the communication message is net limited to FIG. 10B. In FIG. 10B, the same reference numerals are attached to similar elements as those in FIG. 2E, and the explanation thereabout is omitted.

FIG. 10B illustrates a user message 1070 with which the information processing device 1030 searches the communication terminal 1020 for information about a user who operates the communication terminal 1020, and the communication terminal 1020 responds to the information processing device 1030, before transmission and reception of the control message 270 transmitted and received in the control channel for each device.

Among the user message 1070, a message sent from the information processing device 1030 to the communication terminal 1020 includes an IP address 1071, a command 1072, and for example, CRC 1073 for error correction. The communication terminal address of the transmission destination and the host address of the transmission source are set as the IP address 1071. As the command 1072, a command of user information acquisition is transmitted.

Among the user message 1070, the user message transmitted from the communication terminal 1020 to the information processing device 1030 includes an IF address 1075, response data 1076, and for example, CRC 278 for error correction. The host address of the transmission destination and the communication terminal address of the transmission source are set as the IP address 1075. As the response data 1076, the user information is transmitted.

In the protocol, user information may be transmitted from the communication terminal 1020 to the information processing device 1030 without any inquiry from the information processing device 1030 to the communication terminal 1020.

### (Application Activation Table)

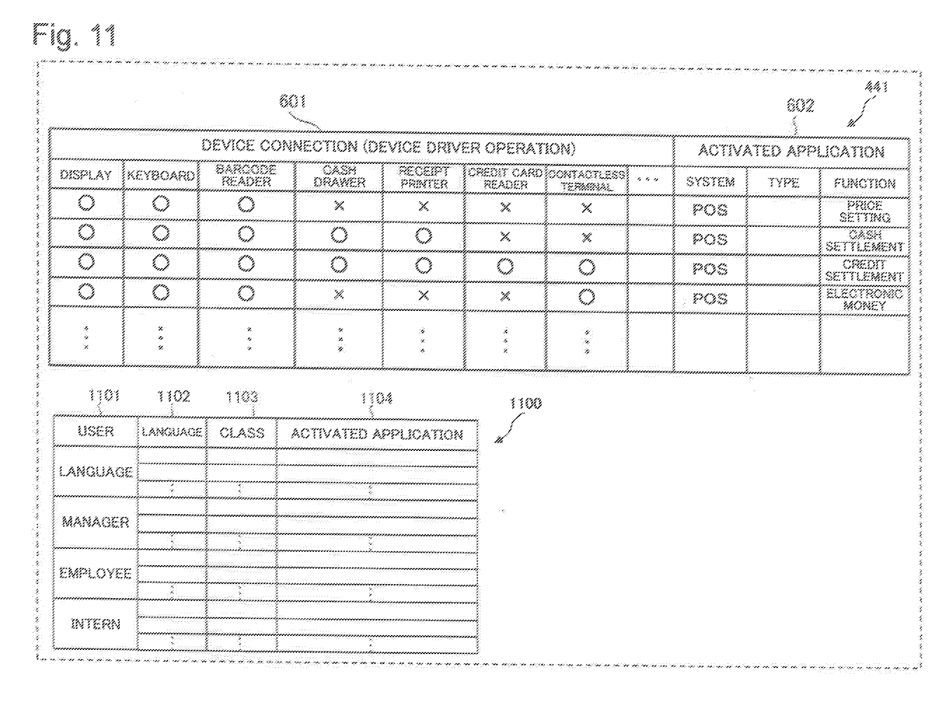

FIG. 11 is a figure illustrating a configuration of an application activation table according to the present example embodiment. In FIG. 11, the same reference numerals are attached to similar elements as those in FIG. 6, and the explanation thereabout is omitted.

In FIG. 11, the table 1100 that stores the activation application related to the user stores an activated application 1104 in relation to a set of a user 1101 of the application, a language 1102 to be used, and a class 1103 of the application. The condition other than the user 1101 is not limited thereto.

### (Application Activation Processing)

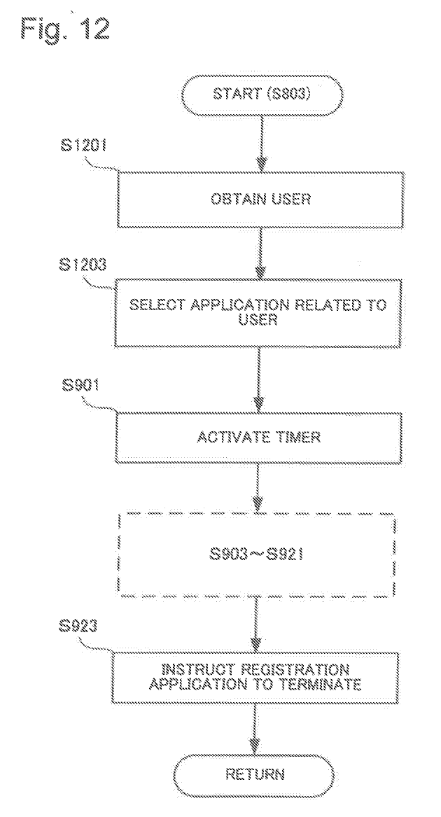

FIG. 12 is a flowchart illustrating a procedure of application activation processing according to the present example embodiment. In FIG. 12, steps S901 to S923 are similar to those in FIG. 9, and the explanation thereabout is omitted.

The information processing device 1030 acquires the user or information including the user in step S1201. In step S1203, the information processing device 1030 refers to the table 1100 and selects the activation application based on the user or information including the user.

According to the present example embodiment, the activation application is selected according to the user or information including the user, and therefore, the application related to user can be activated.

### Fourth Example Embodiment

Subsequently, the information processing system according to the fourth example embodiment of the present invention will be explained. The information processing system according to the present example embodiment differs from the second example embodiment and the third example embodiment in that an activation application is selected in relation to a login terminal. Since the other configuration and operation are similar to those of the second example embodiment and the third example embodiment, the same configuration and operation will be denoted with the same reference numerals, and the detailed explanation thereabout is omitted. Although not shown, the information processing system of the present example embodiment confirms a login terminal as connection confirmation 1036 of FIG. 10A.

### (Application Activation Table)

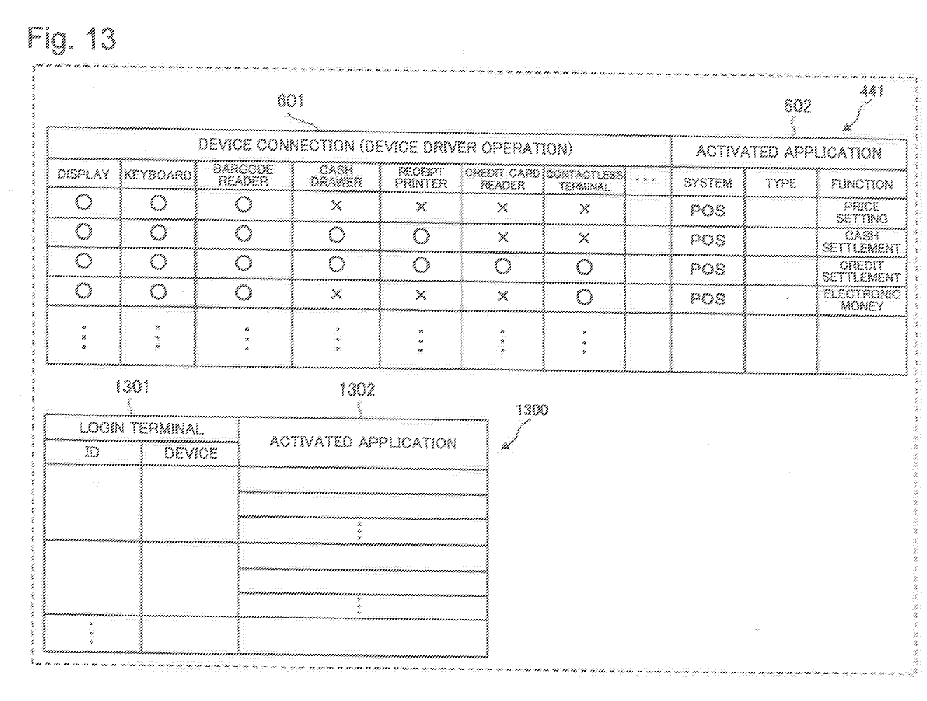

FIG. 13 is a figure illustrating a configuration of an application activation table according to the present example embodiment. In FIG. 13, the same reference numerals are attached to similar elements as those in FIG. 6, and the explanation thereabout is omitted.

In FIG. 13, a table 1300 that stores an activation application related to a login terminal stores an activation application 1302 related to a login terminal 1301 that requested the activation of the application. The information about the login terminal 1301 includes a terminal ID, a model, and the like. It should be noted that the information about the login terminal 1301 is not limited thereto.

### (Application Activation Processing)

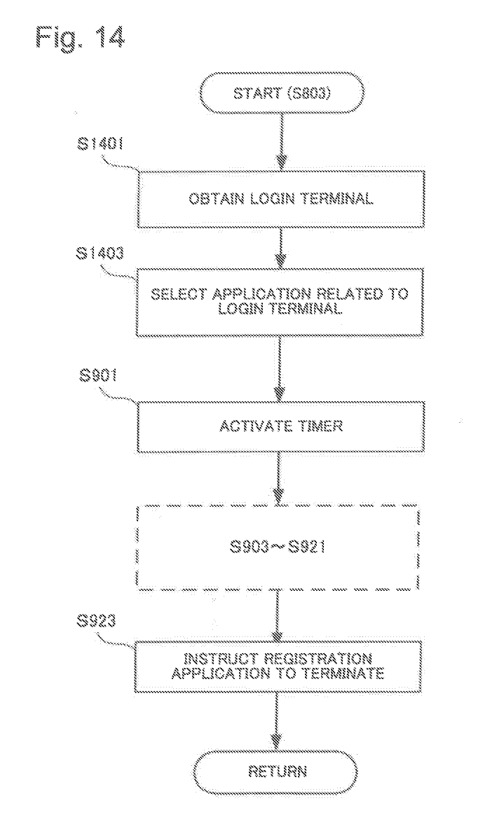

FIG. 14 is a flowchart illustrating a procedure of application activation processing according to the present example embodiment. In FIG. 14, steps S901 to S923 are similar to those in FIG. 9, and the explanation thereabout is omitted.

The information processing device acquires the information about the login terminal in step S1401. In step S1403, the information processing device refers to the table 1300 and selects the activation application based on the information about the login terminal.

According to the present example embodiment, the activation application is selected according to the login terminal information, and therefore, the application related to login terminal can be activated.

### Fifth Example Embodiment

Subsequently, an information processing system according to the fifth example embodiment of the present invention will be explained. The information processing system of the present example embodiment differs from that in the second example embodiment to the fourth example embodiment in that operations performed by a plurality of users or operations performed on a plurality of login terminals are shared. Since the ether configuration and operation are similar to those of the second example embodiment to the fourth example embodiment, the same configuration and operation will be denoted with the same reference numerals, and the detailed explanation thereabout is omitted.

### <<Information Processing System>>

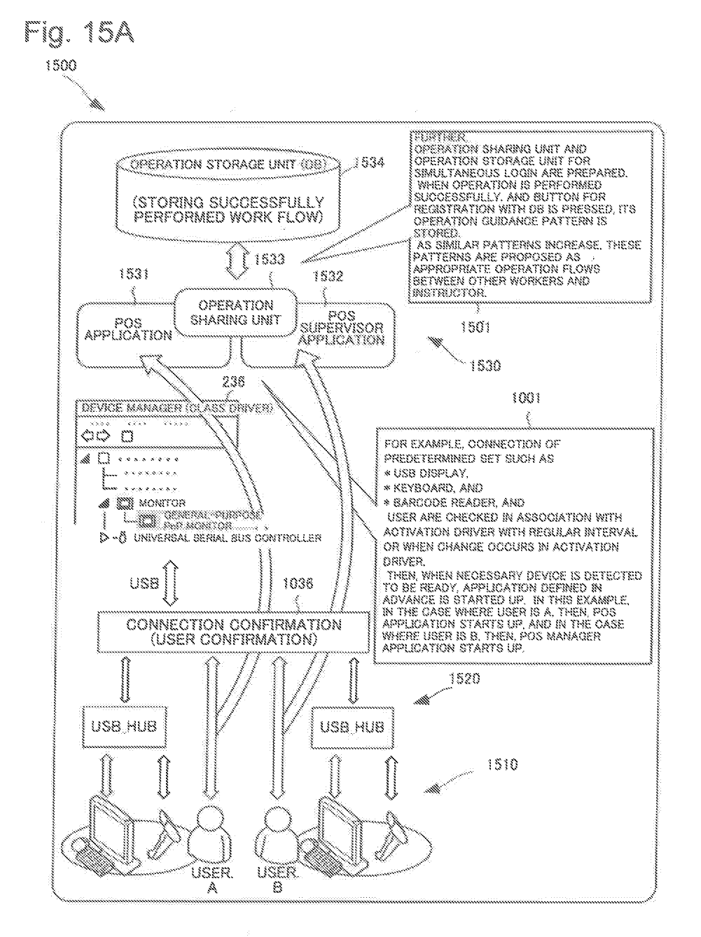

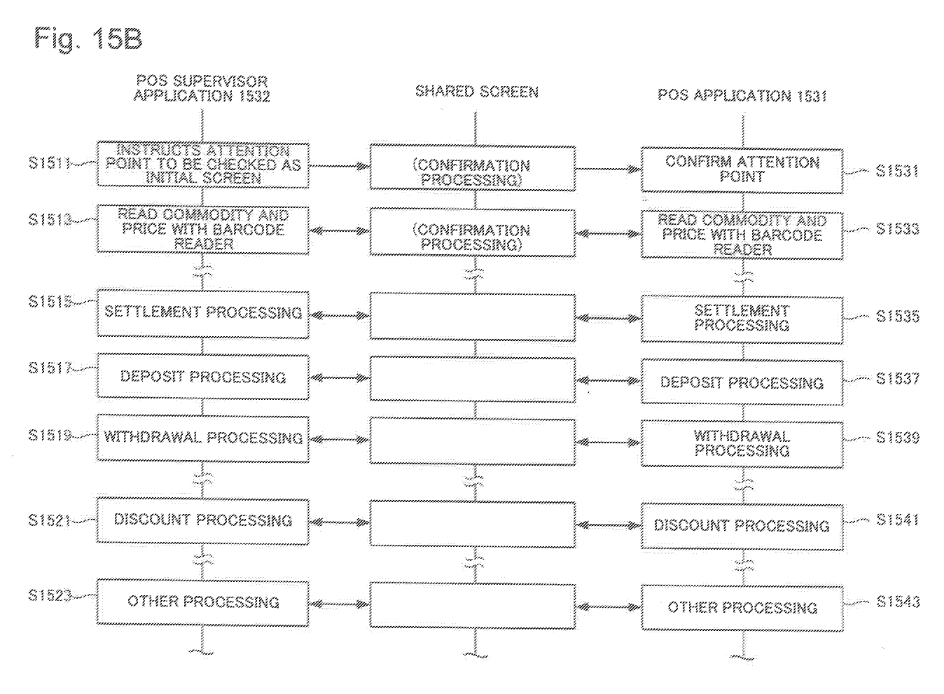

FIG. 15A is a figure illustrating an operation of an information processing system 1500 including an information processing device and a remote device according to the present example embodiment. In FIG. 15A, the same reference numerals are attached to similar constituent elements as those in FIG. 2A or FIG. 10A.

The information processing system 1500 includes an information processing device 1530 which confirms the user in a connection confirmation 1036, and executes a POS application (POS application in the figure) 1031 and a POS supervisor application (POS supervisor application in the figure) 1032 related to the user. The information processing device 1530 further includes an operation sharing unit 1533 for sharing operations with the POS application 1031 and the POS supervisor application 1032.

More specifically, in the information processing system 1500, as described in a comment 1501, an operation sharing unit 1533 and an operation storage unit (DB) 1534 for simultaneous login are prepared. When an operation is performed successfully, and a button for registration with the DB is pressed in the communication terminal 1520, its operation guidance pattern is stored to the operation storage unit (DB) 1534. As patterns similar to those in the operation storage unit (DB) 1534 increase, these patterns are proposed as appropriate operation work flows between other workers (employees) and the instructor.

The information processing system 1500 includes a communication terminal 1520 communicatively connected to the information processing device 1530 and a device 1510 connected to the communication terminal 1520 via a bus. The POS application 1031 and the POS supervisor application 1032 may activate in relation to each of the plurality of communication terminals 1520 or may activate in relation to each of a plurality of devices connected to one communication terminal 1520.

The information processing device 1530 uses a device manager 236 to manage a directly connected device and a device remotely connected via the communication terminal 1520. A device remotely connected via the communication terminal 1520 is preferably controlled by a device driver that operates in a cooperative manner with the information processing device 1530 and the communication terminal 1520.

When the management screen of the connection devices is displayed by the device manager 236 in the information processing device 1530 of FIG. 15A, a directly connected device and a device remotely connected via the communication terminal 1320 are displayed in a similar manner and can be selected. The information processing device 1530 in FIG. 15A may be a desktop PC and a laptop computer, or a virtual PC structured in a cloud server.

In the information processing system 1500, as described in a comment 1001, for example, a connection of a predetermined device set such as a USB display (monitor), a keyboard, and a barcode reader, and the user of the application to be activated are checked in relation to an activation driver with a regular interval or when a change occurs in the activation driver. Then, when a necessary device is detected to be ready, an application defined in advance in relation to the user is activated. In this example, in the case where the user is an employee, i.e., user A, then, the normal POS application 1031 activates, and in the case where the user is a manager, i.e., user B, then, the POS supervisor application 1032 activates, and the operation is shared.

FIG. 15B is a figure illustrating an operation of operation sharing of the information processing system 1500 according to the present example embodiment. In FIG. 15, screen sharing is explained, but sharing of a keyboard, a pointing device, and/or other devices are also similar.

As shown in FIG. 15B, the screen operation in the POS supervisor application 1532 and the screen operation in the POS application 1531 are shared, and the manager and the employee can transmit or learn the operation of the POS device while watching the same screen.

For example, when the manager instructs an attention point to be cheeked as the initial screen in step S1511, the employee can confirm the attention point in step S1531. When the manager reads a commodity and a price with the barcode reader in step S1513, and, on the other hand, the employee reads the same commodity and price with the barcode reader in step S1533, the validity of the operation can be confirmed on the common screen. The operations can also be confirmed in the settlement processing (S1515 and S1535), the deposit processing (S1517 and S1537), and the withdrawal processing (S1519 and S1539). Further, the correctness can also be confirmed on the common screen in the discount processing (S521 and S1541) and further advanced processing (S1523 and S1543).

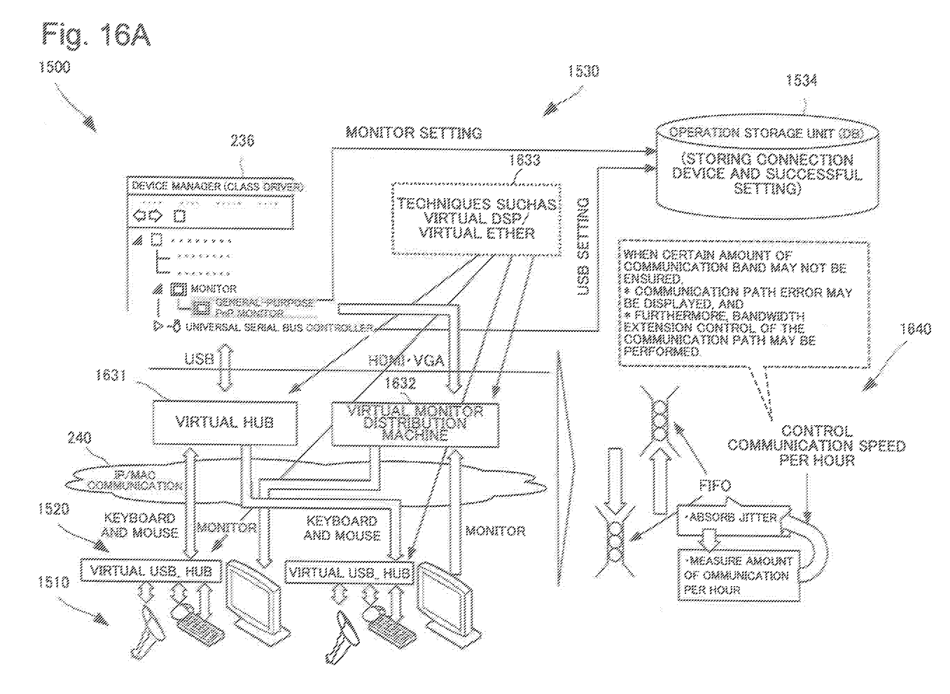

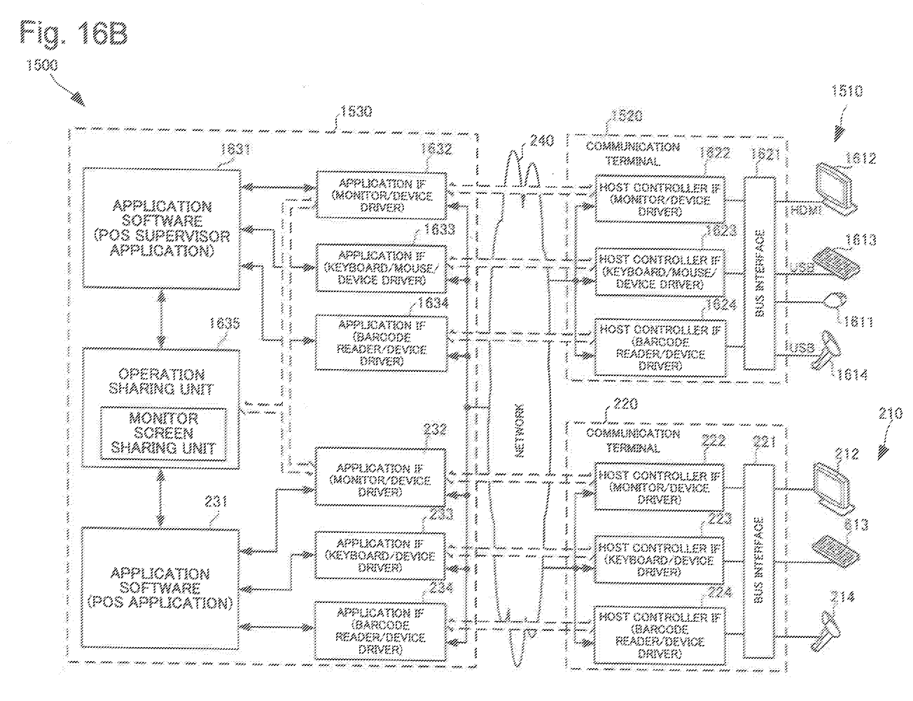

FIG. 16A is a figure illustrating a configuration of operation sharing of the information processing system 1500 according to the present example embodiment. FIG. 16A is a diagram embodying the configuration of FIG. 15A as a POS system. In FIG. 16A, functional constituting units similar to those in FIG. 15A are denoted with the same reference numerals, and the explanation thereabout is omitted.

In FIG. 16A, a screen is snared by a monitor distribution machine 1632 which makes a display, i.e., a monitor, into software, and operation sharing is achieved with HUB 1631 which makes a keyboard and a mouse into software. Techniques such as virtual DSP (digital signal processor), virtual Ether, and the like are used for such screen sharing and operation sharing (see 1633).

A FIFO (first-in first-out) buffer is provided to absorb jitter occurring in the network (IP/MAC communication) 240. When a certain amount of communication band cannot be ensured even when the FIFO buffer is provided, a communication path error may be displayed, and furthermore, bandwidth extension control of the communication path may be performed (see 1640).

FIG. 16B is a figure illustrating a concept of operation sharing of the information processing system 1500 according to the present example embodiment. FIG. 16B illustrates a configuration of a device driver between the information processing device 1530 and the communication terminals 220, 1520 according to the present example embodiment. In FIG. 16B, the same reference numerals are attached to similar constituent elements as those in FIG. 2C, and the explanation thereabout is omitted.

In the lower part of FIG. 16B, the configuration of the information processing device 1530, the communication terminal 220, and the device 210 are the same as those in FIG. 2C, so the description thereabout is omitted. FIG. 16B additionally illustrates the configurations of the information processing device 1530, the communication terminal 1520, and the device 1510 for operation sharing.

FIG. 16B illustrates a state in which a display 1612 as a monitor, a keyboard 1613 for an input instruction, and a barcode reader 1614 for reading commodity information are connected to the communication terminal 1520 as the minimum, devices to activate POS application, and each device driver has been activated. The display 1612, the keyboard 1613, and the barcode reader 214 are connected to the bus interface 1621 of the communication terminal 1520.

The host controller interface 1622 of the communication terminal 1520 and the application interface 1632 of the information processing device 1530 are activated as the monitor device driver for controlling the display 1612. A pipe is established via the network 240 between the host controller interface 1622 and the application interface 1632, the host controller interface 1623 of the communication terminal 1520 and the application interface 1633 of the information processing device 1530 are activated as the keyboard device driver for controlling the keyboard 1613. A pipe is established via the network 240 between the host controller interface 1623 and the application interface 1633. The host controller interface 1624 of the communication terminal 1520 and the application interface 1634 of the information processing device 1530 are activated as the barcode reader device driver for controlling the barcode reader 1614. A pipe is established via the network 240 between the host controller interface 1624 and the application interface 1634.

The information processing device 1530 checks whether the application interfaces 232 to 234 have activated, and when the monitor, the keyboard, and the barcode reader are determined to be usable, the information processing device 1530 activates the POS application 231 as application software. The information processing device 1530 checks whether the application interfaces 1632 to 1634 have activated, and when the monitor, the keyboard, and the barcode reader are determined to be usable, the information processing device 1530 activates the POS supervisor application 1631 as the application software.

The information processing device 1530 activates the POS application 231 and the POS supervisor application 1631, and shares, for example, a monitor screen via the operation sharing unit 1635, the monitor screen of the operation sharing unit 1635 is transmitted to the display 1612 via the application interface 1632, the network 240 and the host controller interface 1622, and is transmitted to the display 212 via the application interface 232, the network 240, and the host controller interface 222, and the monitor screen is shared.

In this way, the monitor screen is shared between the POS application 231 and the POS supervisor application 1631. Other devices are also shared for operation in a similar manner.

### (Application Activation and Operation Sharing Table)

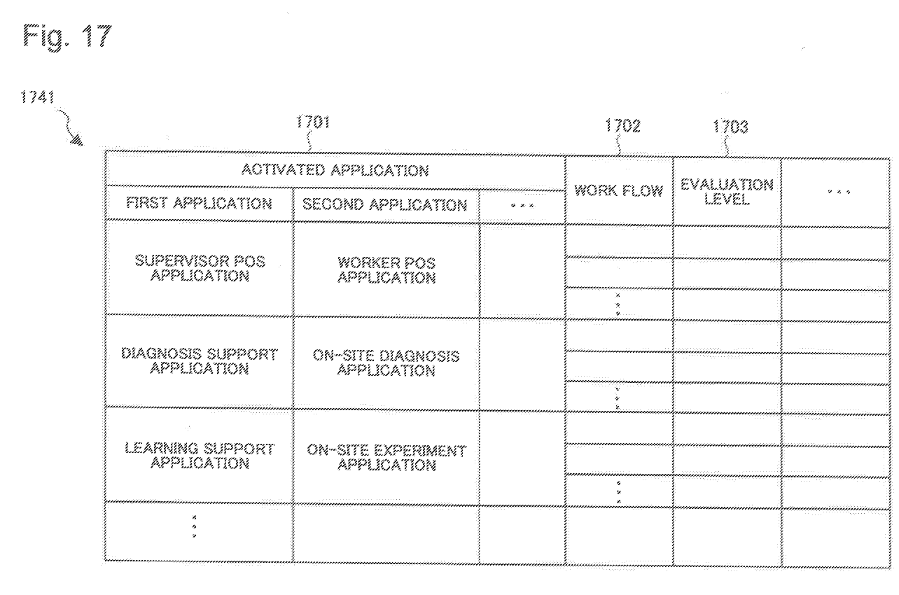

FIG. 17 is a figure illustrating a configuration of the application activation and operation sharing table 1741 according to the present example embodiment. FIG. 17 is accumulated in the operation storage unit 1534 of FIG. 15A to be used for learning of the application activation and operation sharing.

The application activation and operation sharing table 1741 stores a plurality of work flows 1702 and an evaluation level 1703 of each work flow in relation to an activated application 1701 for which operation is shared. In this case, the work flow is middleware including a processing procedure between multiple activation applications as shown in FIG. 15B and a processing procedure between operations sharing in a single activation application. The evaluation level 1703 is an evaluation such as whether each work flow is effective as, for example, a learning result.

In the present example embodiment, the application activation table 441 for selecting the activation application is provided separately from the application activation and operation sharing table 1741.

### (Execution State Accumulation Processing)

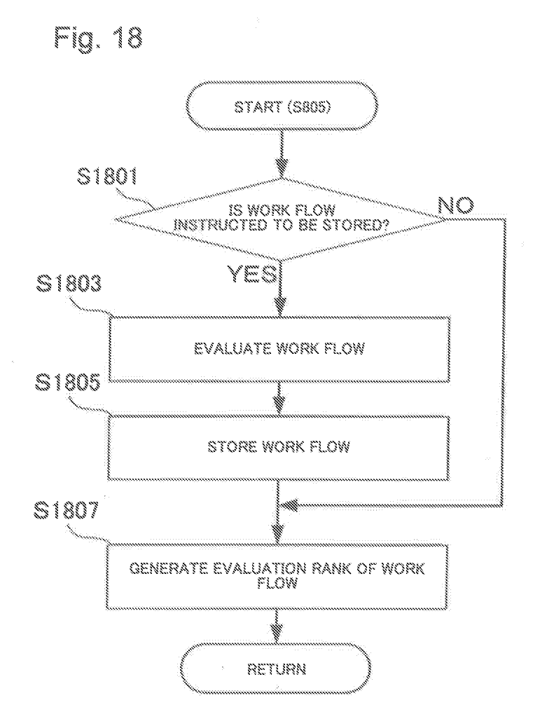

FIG. 18 is a flowchart illustrating a procedure of execution state accumulation processing (S805) according to the present example embodiment.

In step S1801, the information processing device 1530 determines whether a work flow is instructed to be stored after the application activation processing is terminated. When the work flow is instructed to be stored, the information processing device 1530 evaluates the work flow in step S1803. Then, the information processing device 1530 stores the work flow in step S1805.

When the work flow is not instructed to be stored or alter the work flow is stored, the information processing device 1530 generates an evaluation rank of the stored work flow to allow the work flow to be used later in step S1807.

According to the present example embodiment, the application using the desired device can be stably activated, and the operation sharing of the activation application can be achieved.

### Sixth Example Embodiment

Subsequently, an information processing system according to the sixth example embodiment of the present invention will be explained. The information processing system according to the present example embodiment differs from that of the second example embodiment to the fifth example embodiment in that a work flow is evaluated and stored by voice. Since the other configuration and operation are similar to those of the second example embodiment to the fifth example embodiment, the same configuration and operation will be denoted with the same reference numerals, and the detailed explanation thereabout is omitted.

### <<Information Processing System>>

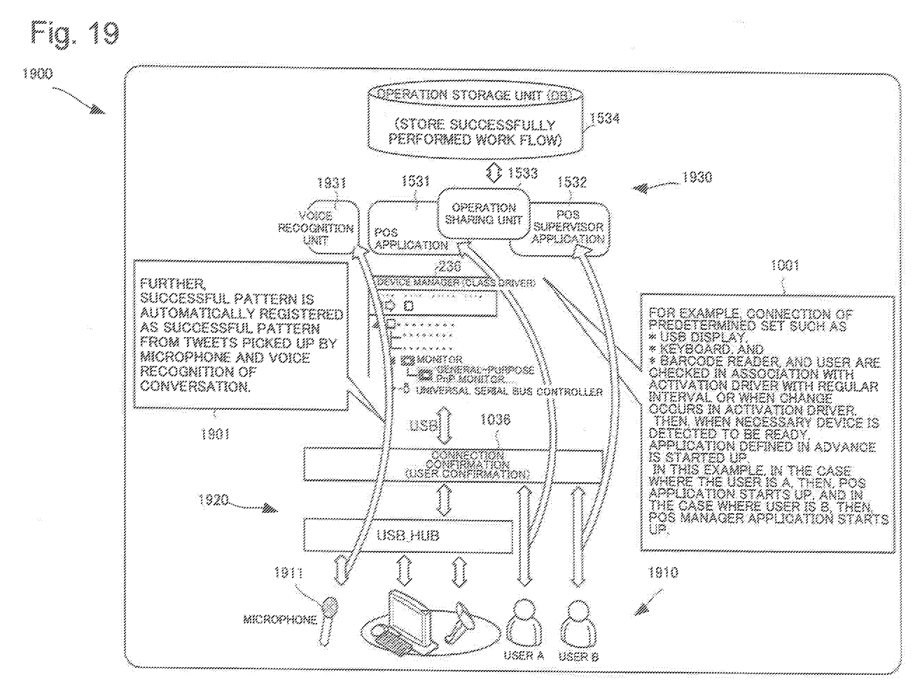

FIG. 19 is a figure illustrating an operation of an information processing system 1900 including an information processing device and a remote device according to the present example embodiment. In FIG. 19, the same reference numerals are attached to similar constituent elements as those in FIGS. 2A, 10A or 15A.

The information processing system 1900 includes an information processing device 1930 which executes a POS application (POS application in the figure) 1531 and a POS supervisor application (POS supervisor application in the figure) 1532 and includes an operation sharing unit 1533 which shares operation on the POS application 1531 and the POS supervisor application 1532. The information processing device 1930 further includes a voice recognition unit 1931 for recognizing speech obtained by a microphone 1911.

More specifically, in the information processing system 1900, as described in a comment 1901, successful registration pattern with which operation is successfully performed is automatically registered as a successful pattern from tweets picked up by the microphone and voice recognition of conversation.

The information processing system 1900 includes a communication terminal 1920 communicatively connected to the information processing device 1930 and a device 1910 including the microphone 1911 connected to the communication terminal 1920 via a bus.

### (Execution State Accumulation Processing)

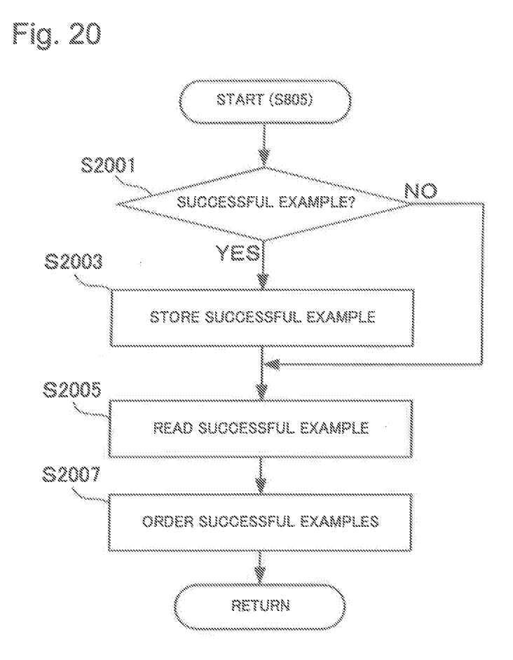

FIG. 20 is a flowchart illustrating a procedure of execution state accumulation processing (S805) according to the present example embodiment.

After the information processing device 1930 terminates the application activation processing in step S2001, the information processing device 1930 determines whether the work flow in question is a successful example from tweets picked up by the microphone 1911 and voice recognition of conversation. In a case where the work flow in question is determined to be a successful example, the information processing device 1930 stores the work flow of the successful example in step S2003.

Then, the information processing device 1930 reads the stored successful example in step S2005, and in step S2007, the information processing device 1930 orders the successful example to allow the work flow to be used later.

According to the present example embodiment, the application using the desired device can be activated stably, and the operation sharing by the activation application can be achieved and the successful example of the work flow of the operation sharing can be automatically obtained.

### Seventh Example Embodiment

Subsequently, an information processing system according to the seventh example embodiment of the present invention will be explained. The information processing system according to the present example embodiment differs from those of the second example embodiment to the sixth example embodiment in that another associated application is activated. Since the other configuration and operation are similar to those of the second example embodiment to the sixth example embodiment, the same configuration and operation will be denoted with the same reference numerals, and the detailed explanation thereabout is omitted.

### <<Information Processing System>>

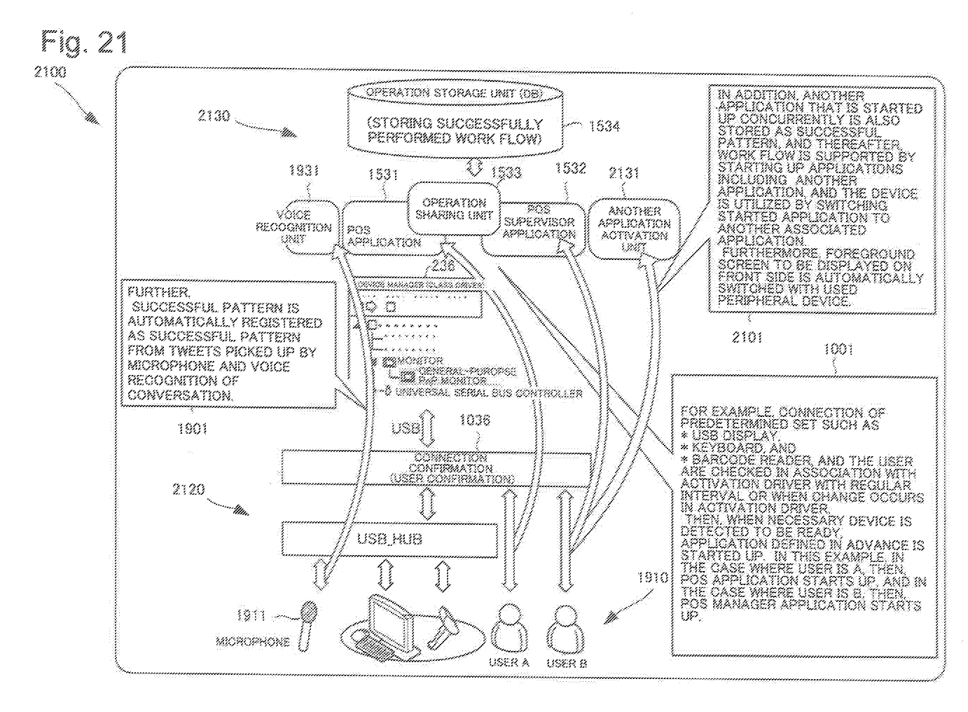

FIG. 21 is a figure illustrating an operation of an information processing system 2100 including an information processing device and a remote device according to the present example embodiment. In FIG. 21, the same reference numerals are attached to similar constituent elements as those in FIGS. 2A, 10A, 15A, or 19.

The information processing system 2100 includes an information processing device 1930 which executes a POS application (POS application in the figure) 1531 and a POS supervisor application (POS supervisor application in the figure) 1532 and includes an operation sharing unit 1533 which shares operation on the POS application 1531 and the POS supervisor application 1532, the information processing device 1930 further includes a voice recognition unit 1931 for recognizing speech obtained by a microphone 1911, and further includes another application activation unit 2131 for activating another associated application.

More specifically, in the information processing system 2100, as described in a comment 2101, in addition, another application that is activated concurrently is also stored as a successful pattern, and thereafter, a work flow is supported by activating applications including the another application, and the device is utilized while switching the activated application to the another associated application. Furthermore, the foreground screen to be displayed on the front side is automatically switched with a used peripheral device.

The information processing system 2100 includes a communication terminal 2120 communicatively connected to the information processing device 2130.

### (Application Activation and Associated Application Table)

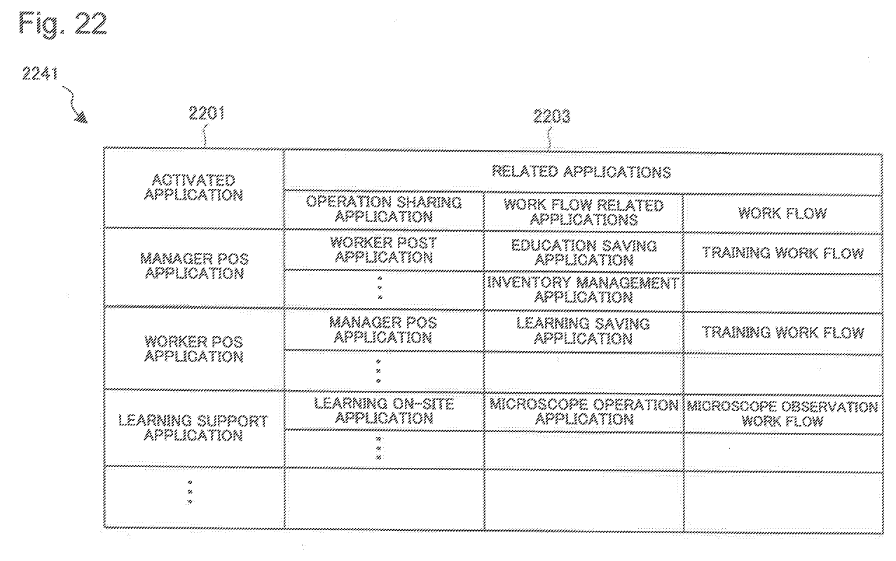

FIG. 22 is a figure illustrating a configuration of an application activation and associated application table 2241 according to the present example embodiment. FIG. 22 is accumulated in the operation storage unit 1534 of FIG. 21 to be used for application activation and associated application activation.

The application activation and associated application table 2241 stores an application 2203 that is activated in relation to the activated application 2201. In this case, the application 2203 that is activated in association therewith includes an operation sharing application with which operation sharing is performed, a work flow associated application associated in the work flow, and the work flow thereof.

In the present example embodiment, the application activation table 441 for selecting the activation application is provided separately from the application activation and operation sharing table 1741.

### (Execution State Accumulation Processing)

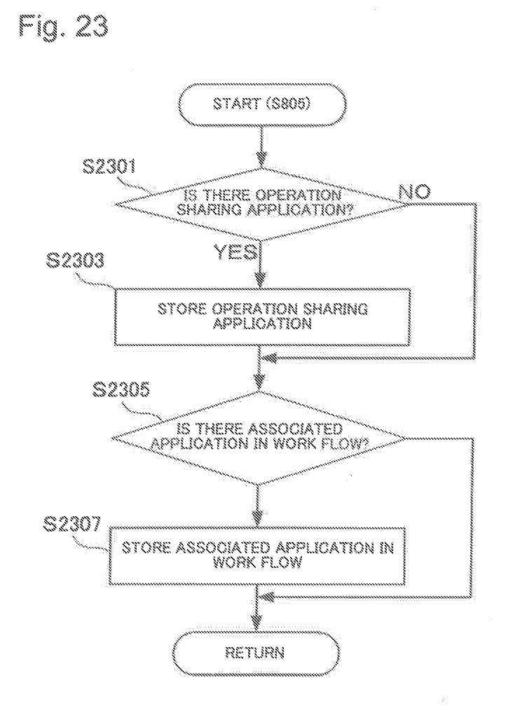

FIG. 23 is a flowchart illustrating a procedure of execution state accumulation processing (S805) according to the present example embodiment.

In step S2301, the information processing device 2130 determines whether there is any application of which operation is shared after the application activation processing is terminated. When there is an application of which operation is shared, the information processing device 2130 stores an operation sharing application as an associated application 2203 in step S2303.

In step S2305, the information processing device 2130 determines whether there is any associated application in the work flow. When there is an application associated with the work flow, the information processing device 2130 stores the work flow association application and the relating work flow as the association application 2203 in step S2307.

According to the present example embodiment, the application using the desired device can be activated stably, and the operation sharing by the activation application can be achieved and the associated application can be activated.

### Eighth Example Embodiment

Subsequently, an information processing system according to the eighth example embodiment of the present invention will be explained. The information processing system according to the present example embodiment differs from those of the second example embodiment to the seventh example embodiment in that multilingual processing is performed at a restaurant where employees and customers speaking multiple languages gather. Since the other configuration and operation are similar to those of the second example embodiment to the seventh example embodiment, the same configuration and operation will be denoted with the same reference numerals, and the detailed explanation thereabout is omitted.

### <<Information Processing System>>

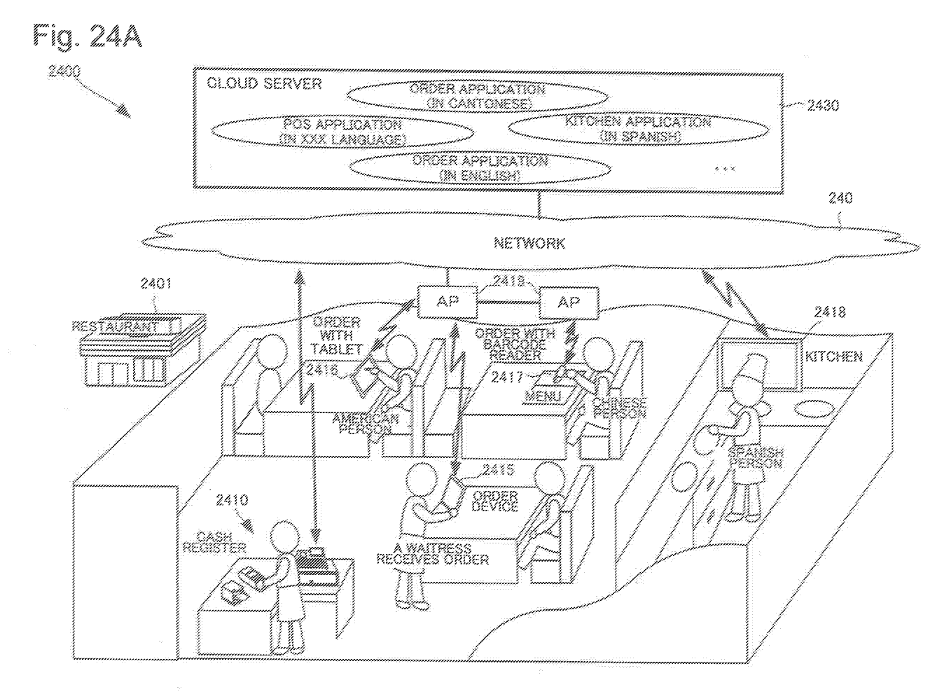

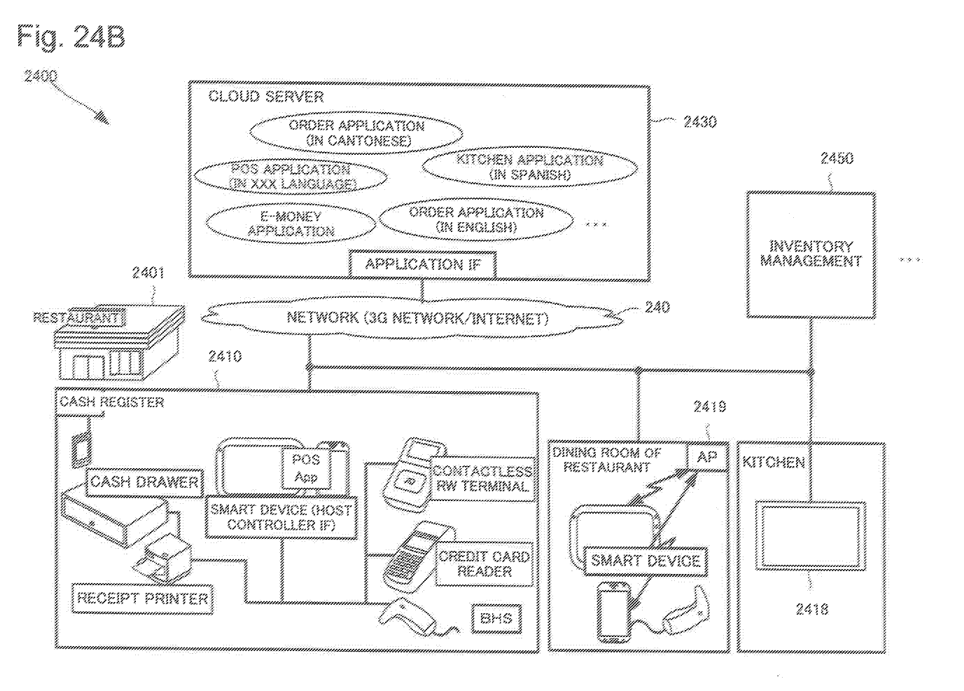

FIG. 24A is a figure illustrating an operation of an information processing system 2400 including an information processing device and a remote device according to the present example embodiment.

The information processing system 2400 includes a cloud server 2430 and a network 240 connecting the cloud server 2430 and a communication terminal at a restaurant 2401.

When multilingual applications such as, for example, a POS application relating to various languages, an order application in Cantonese and English, a kitchen application in Spanish, and the like are prepared as activation applications in needed devices, and the use languages are determined, the cloud server 2430 is executed such that information may be exchanged with each other between different languages.

The communication terminals in the restaurant 2401 include a cash register processing terminal 2410 of the POS system according to the above example embodiment. The communication terminals of the restaurant 2401 includes a tablet 2416 with which a customer can place an order on the display screen, a smartphone 2417 which is connected, via USB, a barcode reader for reading an order barcode to allow a customer to place an order, and a dedicated terminal 2415 which is used by a waitress to place an order. The communication terminal of the restaurant 2401 includes a display 2418 for monitor which displays the order in the kitchen.

Further, the information processing system 2400 may have an AP (Access Point) 2419 that provides a relay for the communication terminal to the network 240.

In this way, an American person places an order on the English screen, a Chinese person places an order on the Chinese menu, and a Spanish cook in the kitchen cooks while watching the order in Spanish.

FIG. 24B is a figure illustrating a configuration of an information processing system 2400 according to the present example embodiment. In FIG. 24B, similar constituent elements as those in FIG. 2B will not be explained.

The information processing system 2400 includes a cloud server 2430, each communication terminal as a smart device disposed in the restaurant 2401, a network 240 including 3G network and the Internet connecting the cloud server 2430 and each communication terminal, and a device connected to each communication terminal via a bus.

The configuration of the cash register 2410 is similar to that of the store device in FIG. 2B. In the dining room of restaurant, the AP 2419 relays the smart device so as to allow connection of the smart device. In the kitchen, the display 2418 is connected. Further, a smart device for inventory management 2450 and the like may be connected.

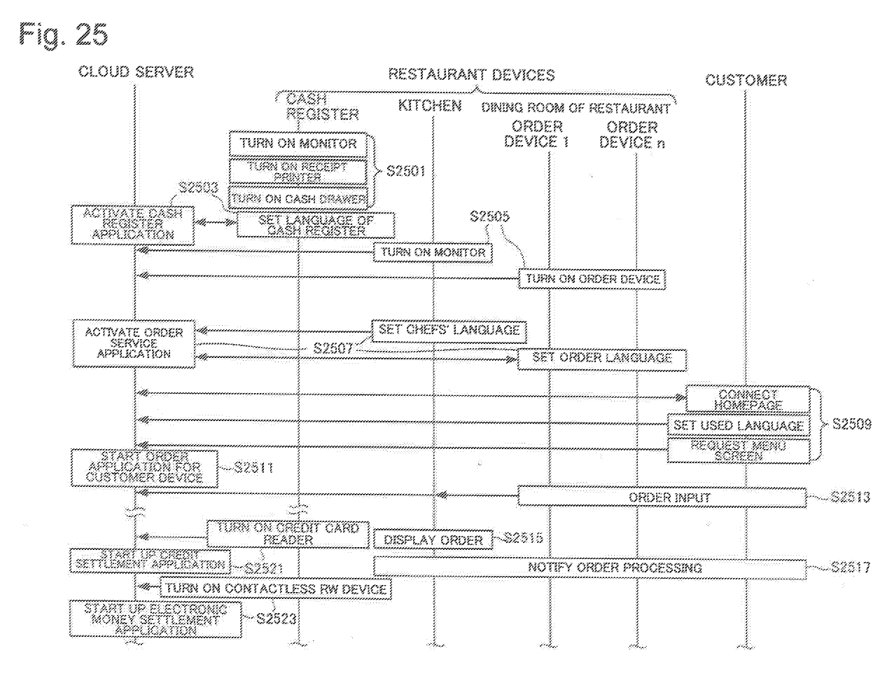

FIG. 25 is a sequence diagram illustrating an operation procedure of the information processing system 2400 according to the present example embodiment.

In the cash register, in step S2501, the device is connected to the communication terminal and the device driver activates. In step S2503, the cloud server cheeks the activated device driver and activates the cash register application supporting the cash register language.

In step S2505, when the monitor in the kitchen is turned on and the order device in the dining room is turned on, the cloud server activates the order service application supporting the chefs language or the order language in step S2S07.

In step S2509, when a customer uses the customer's smart device to connect to the homepage of the restaurant, sets the language to be used, and makes a display request of the menu screen, then, the cloud server activates the order application for the customer device in step S2511.

Thereafter, in step S2513, an order is input from the device in the dining room of the restaurant or the customer's device. In the kitchen, in step S2515, the order is displayed in the chefs language, and in step S2517, order processing notification is given in each language.

During settlement, a cash settlement is made as it is, but when the credit card reader is turned ON in the cash register, the credit settlement application activates in the credential server in step S2521. In step S2S23, when the non-contact RW device is turned on in the cash register, the electronic money settlement application activates on the cloud server.

### (Application Activation Table)

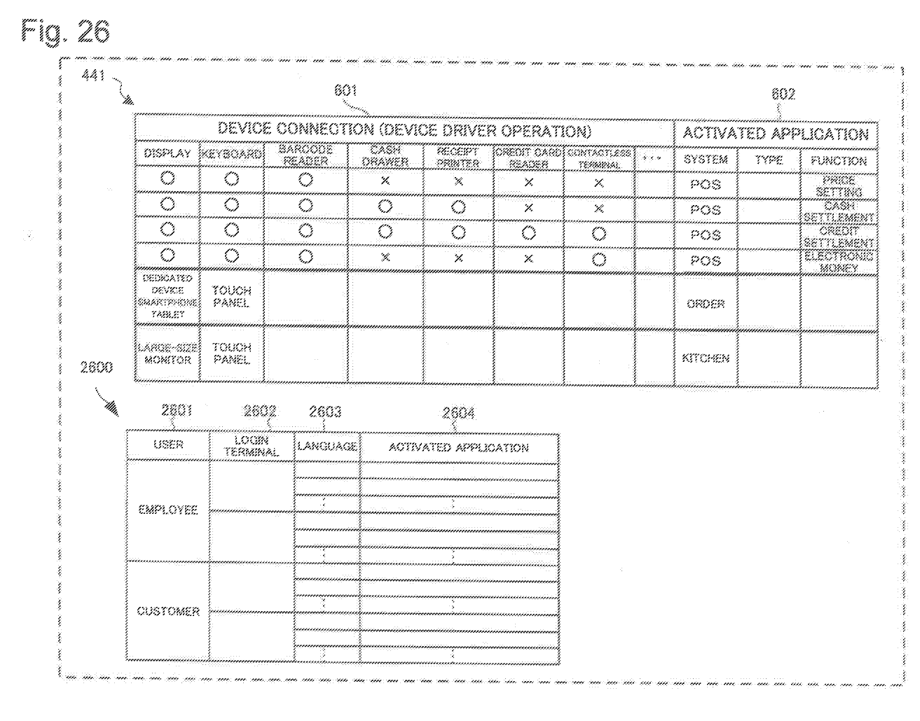

FIG. 26 is a figure illustrating a configuration of an application activation table according to the present example embodiment. In FIG. 26, the same reference numerals are attached to similar elements as those in FIGS. 6, 11, or 13, and explanation thereabout is omitted

In FIG. 26, activation conditions for not only the POS applications but also order applications and kitchen applications are added to the application activation table 441.

In FIG. 26, a table 2600 storing an activation application stores an activated application 2604 in relation to each set of a user 2601 of the application, a login terminal 2602, and a language 2603 to be used. It should be noted that the condition is not limited thereto.

### <<Processing Procedure of Information Processing Device>>

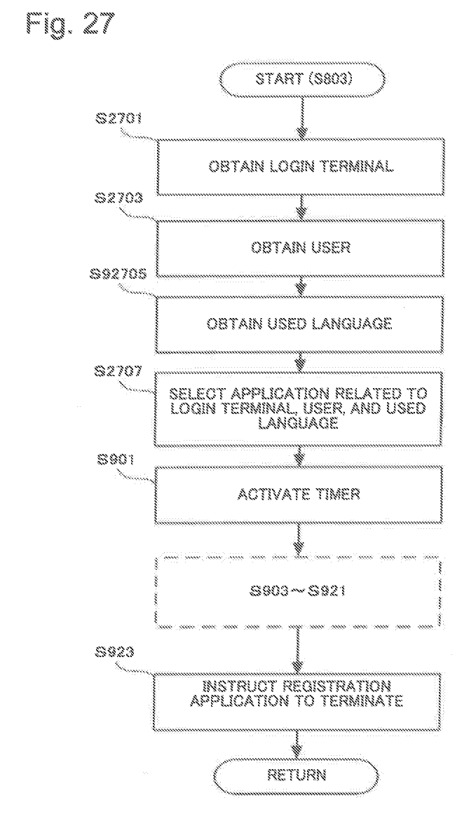

FIG. 27 is a flowchart illustrating a procedure of application activate processing (S803) according to the present example embodiment. In FIG. 27, steps S901 to S923 are similar to those in FIG. 9, and explanation thereabout is omitted.

The cloud server 2430 serving as the information processing device obtains the information about the login terminal in step S2701. In step S2703, the cloud server 2430 obtains the user or information including the user. In step S2705, the cloud server 2430 obtains information about the language used. In step S2707, the cloud server 2430 selects the application related to the login terminal, the user, and the language used.

According to the present example embodiment, the application supporting the language of the user using the desired device can be activated stably.

### Ninth Example Embodiment

Subsequently, an information processing system according to the ninth example embodiment of the present invention will be explained. The information processing system according to the present example embodiment differs from those of the second example embodiment to the eighth example embodiment in that different data is communicated between the information processing device 230 (virtual PC) and the communication terminal 220 to which the device is connected. More specifically, in the present example embodiment, the application IF of the information processing device 230 and the host controller IF of the communication terminal 220 are separated by a part different from the second example embodiment. For example, in a case where the entire device driver including the host controller chip (HC) is realized with software, a set of a host controller driver and a host controller chip is divided in view of the communication efficiency and the communication speed in various layers. The information processing system is designed such that information between the divided layers is communicated over the network between the information processing device 230 and the communication terminal 220. Since the other configuration and operation are similar to those of the second example embodiment to the eighth example embodiment, the same configuration and operation will be denoted with the same reference numerals, and the detailed explanation thereabout is emitted.

### (Example of Data Transmission)

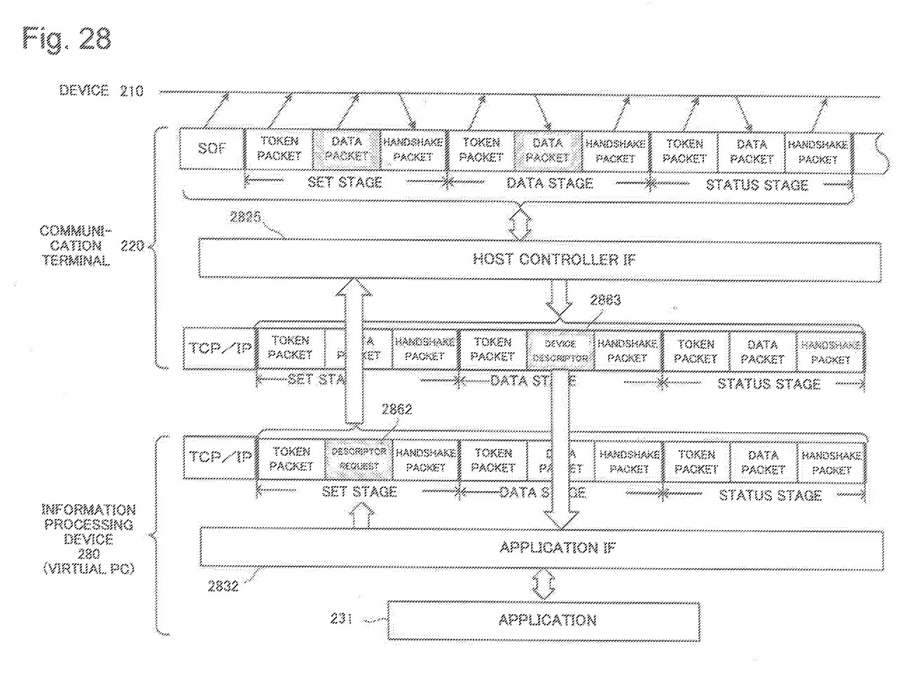

FIG. 28 is a figure illustrating data transmission in the information processing system according to the present example embodiment. Like FIG. 2G, FIG. 28 is a figure illustrating descriptor acquisition procedure of a USB device connected via USB. Therefore, in FIG. 28, the same reference numerals are attached to similar constituent elements as those in FIG. 2G, and explanation thereabout is omitted.

The descriptor set in the device 210 is acquired by a USB request such as GET_DESCRIPTOR. A frame including USB protocol of USB request which is control transfer is exchanged between the information processing device 230 and the device 210. Each control transfer includes set stage, data stage, and status stage. Each stage includes a token packet, a data packet, and a handshake packet. The descriptor is obtained in a data packet of each data stage. The descriptor obtained from the device 210 is inserted into a frame IP-encapsulated with an IP header and a TCP header, and transmitted from the portable terminal 220 to the information processing device 230.

In this case, in accordance with the device input and output request of the application 231, first, an application interface 2832 of the information processing device 230 generates a frame including USB protocol of USB request of GET DESCRIPTOR to confirm the connection device, and send the frame to the communication control unit 401.

The frame including the USB request of GET DESCRIPTOR IP-encapsulated with the IP header and the TCP header are received and IP-decapsulated by the communication control unit 501 of the communication terminal 220. The USB request of GET DESCRIPTOR is sent to a host controller interface 2825. The host controller interface 2825 instructs a USB bus interface 226 (not shown) to transfer each packet in the USB bus to the device 210 based on the frame including the USB protocol of the USB request of the GET DESCRIPTOR.

The host controller Interface 2825 sends a frame including the data packet received in the data stage from the device 210 as a device descriptor 2863 to the communication control unit 501. The frame including the device descriptor 2863 IP-encapsulated with the IP header and the TCP header is transmitted from the communication control unit 501 of the communication terminal 220 to the communication control unit 401 of the information processing device 230.

When the communication control unit 401 of the information processing device sends the decapsulated frame including the device descriptor 2863 to the application interface 2832, the application interface 2832 notifies the connection device information in response to the device input and output request of the application 231.

Similar data transmission is performed in other control transfer, bulk transfer, interrupt transfer, and isochronous transfer as well. It may be software in which the host controller interface 2825 and the USB bus interface 226 are integrated.

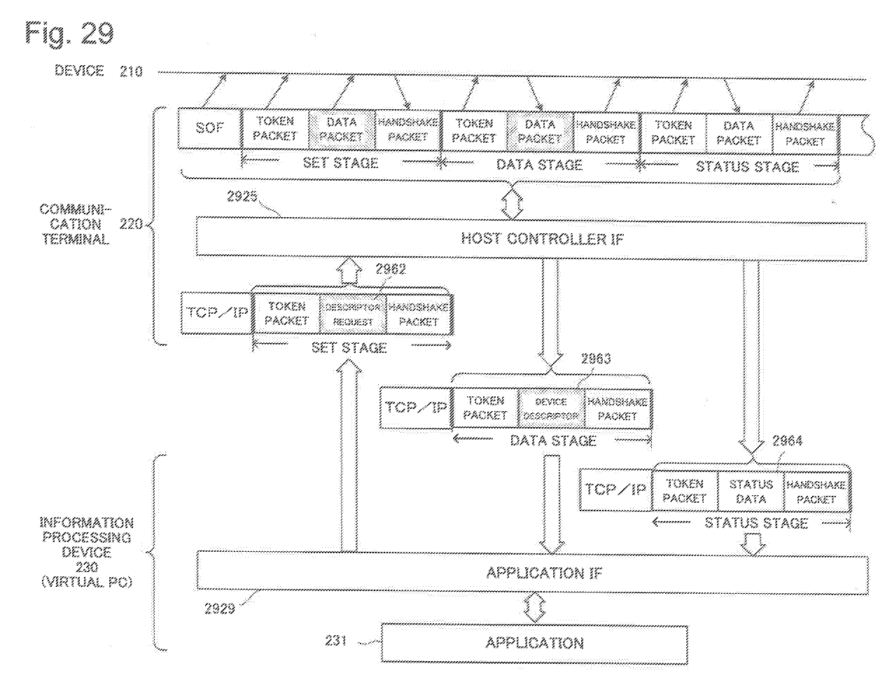

FIG. 29 is a figure illustrating other data transmission in the information processing system according to the present example embodiment. Just like FIG. 2G and FIG. 28, FIG. 29 is a figure illustrating descriptor acquisition procedure of a USB device connected via USB. Therefore, in FIG. 29, the same reference numerals are attached to similar constituent elements as those in FIG. 2G and FIG. 28, and explanation thereabout is omitted.

The descriptor set in the device 210 is acquired by a USB request such as GET_DESCRIPTOR. Control transfer including USB protocol of USB request includes set stage, data stage, and status stage. Each stage includes a token packet, a data packet, and a handshake packet. Each of the set stage, the data stage, and the status stage including USB protocol of USB request which is control transfer is exchanged between the information processing device 230 and the device 210. The descriptor is obtained in a data packet of each data stage. The descriptor obtained from the device 210 is inserted into the data stage IP-encapsulated with an IF header and a TCP header, and transmitted from the portable terminal 220 to the information processing device 230.

In this case, in accordance with the device input and output request of the application 231. First, as application interface 2932 of the information processing device 230 generates a set stage including USB protocol of USB request of GET DESCRIPTOR to confirm the connection device, and send the set stage to the communication control unit 401.

The set stage including the USB request of GET DESCRIPTOR IP-encapsulated with the IP header and the TCP header is received and IF-decapsulated by the communication control unit 501 of the communication terminal 220, the USB request of GET DESCRIPTOR is sent to a host controller interface 2925. The host controller interface 2925 instructs a USB bus interface 226 (not shown) to transfer each packet in the USB bus to the device 210 based on the set stage including the USB protocol of the USB request of the GET DESCRIPTOR.

The host controller interface 2925 sends a data stage including the data packet received in the data stage from the device 210 as a device descriptor 2963 to the communication control unit 501, the data stage including the device descriptor 2963 IP-encapsulated with the IP header and the TCP header is transmitted from the communication control unit 501 of the communication terminal 220 to the communication control unit 401 of the information processing device 230.

When the communication control unit 401 of the information processing device sends the decapsulated data stage including the device descriptor 2963 to the application interface 2932, the application interface 2932 notifies the connection device information in response to the device input and output request of the application 231.

The host controller interface 2925 sends a status stage including the data packet received in the status stage from the device 210 as status data 2964 to the communication control unit 501, the status stage including the status data 2964 IP-encapsulated with the IP header and the TCP header is transmitted from the communication control unit 501 of the communication terminal 220 to the communication control unit 401 of the information processing device 230.

When the communication control unit 401 of the information processing device sends the decapsulated status stage including the status data 2964 to the application interface 2932, the application interface 2932 notifies the connection device information in response to the device input and output request of the application 231.

In the above description, in the application interface 2932. The handshake packet is not determined, but the application interface 2932 may be configured to confirm the handshake packet in each stage.

Similar data transmission is performed in other control transfer, bulk transfer, interrupt transfer, and isochronous transfer as well. It may be software in which the host controller interface 2925 and the USB bus interface 226 are integrated.

According to the present example embodiment, even when the communication between the information processing device (virtual PC) and the communication terminal is communication performed in units of frames or communication performed in units of stages in which the drivers of each other are divided or even when a USB device is connected to a remote communication terminal, the same operation can be performed in the same manner as the information processing device directly connected to the USB device.

### Other Example Embodiments

In the above example embodiment, the connection example of the device using USB and HDMI® is shown, but the same effect can be obtained even with other connections such as SCSI. Furthermore, the present invention can be applied to a case where a device is connected by short-range radio, for example, infrared communication, WiFi, Bluetooth®, and the like, and the same effect can be obtained even in such case.

In the above example embodiment, the POS application of the POS system has been mainly described, but the present invention is not limited to the processing in the POS application of the POS system. For example, the present invention can also be applied to a diagnosis support system in the medical field, a learning support system in the field of education, or a device operation support system in the industrial field and the same effect can be achieved.

Although the present invention has been described with reference to an example embodiments, the present invention is not limited to the above example embodiments. Various changes that can be understood by those skilled in the art within the scope of the present invention can be applied to the configuration of the present invention and in details. A system or a device in which different features included in each example embodiments are combined in any way is also included in the scope of the present invention.

The present invention may be applied to a system constituted by a plurality of devices or may be applied to a single device. Further, the present invention is also applicable when an information processing program that realizes the functions of the example embodiment is supplied directly or remotely to a system or a device. Therefore, in order to realize the functions of the present invention with a computer, a program installed on a computer, a medium storing the program, and a WWW (World Wide Web) server from which the program is downloaded are also included in the scope of the present invention, in particular, at least a non-transitory computer readable medium storing the program for causing the computer to execute processing steps included in the above example embodiment is included in the scope of the present invention.

This application is related to the Japanese patent application filed on the same day (Japanese Patent Application No. 2014-235108, Japanese Patent Application No. 2014-235109, and Japanese Patent Application No. 2014-235110), and the entire disclosures thereof are incorporated herein by reference.

This application claims the priority based on Japanese patent application No. 2014-235111 filed on Nov. 19, 2014, the entire disclosure of which is incorporated herein by reference.

1. An information processing device comprising:
an application storage that stores an application and an associated device required for execution of the application:
one or more processors acting as a device determining unit configured to determine whether the device is usable, depending on whether a device driver for the device is activated; and
the one or more processors acting as an application activation unit configured to activate the application associated with the device that is determined to be usable.

2. The information processing device according to claim 1, wherein the application storage stores an application and a combination of a plurality of associated devices required for execution of the application, and
the application activation unit activates an application related to a combination of a plurality of devices that are determined to be usable

3. The information processing device according to claim 1, further comprising:
the one or more processors acting as an user determining unit configured to determine a user of the information processing device, wherein
the application activation unit activates an application related to the user.

4. The information processing device according to claim 1, further comprising:
the one or more processors acting as a communication terminal detection unit configured to detect the communication terminal connected to the device, wherein
the application activation unit activates an application related to the communication terminal.

5. A control method of an information processing device, comprising:
determining whether a device is usable depending on whether a device driver for the device is activated; and
referring to application storage means that associates and stores an application and a device required for execution of the application to activate the application associated with the device that is determined to be usable.

8. (canceled)

7. An information processing system comprising:
an information processing device;
a communication terminal communicatively connected to the information processing device; and
a device connected to the communication terminal,
wherein the information processing device includes an application interface of a device driver driving the device, and the communication terminal includes a device control interface of the device driver, and
wherein the information processing device includes:
an application storage that stores an application and an associated device required for execution of the application;
one or more processors acting as a device determining unit configured to determine whether the device is usable, depending on whether the application interface of the device driver is activated; and
the one or more processors acting as an application activation unit configured to activate the application associated with the device that is determined to be usable.

8. (canceled)

9. The information processing device according to claim 2, further comprising:
the one or more processors acting as an user determining unit configured to determine a user of the information processing device, wherein
the application activation unit activates an application related to the user.

10. The information processing device according to claim 2, further comprising:
the one or more processors acting as a communication terminal detection unit configured to detect the communication terminal connected to the device, wherein
the application activation unit activates an application related to the communication terminal.

11. The information processing device according to claim 3, further comprising:
the one or more processors acting as a communication terminal detection unit configured to detect the communication terminal connected to the device, wherein
the application activation unit activates an application related to the communication terminal.
